(19) United States
(12) Patent Application Publication
(10) Pub. No.: US 2025/0350109 A1
(43) Pub. Date: Nov. 13, 2025

(54) ELECTRICAL PROTECTION METHODS AND SYSTEMS

(71) Applicants: YORK SIKORA, OTTAWA (CA); RICHARD LEMIEUX, KIPAWA (CA)

(72) Inventors: YORK SIKORA, OTTAWA (CA); RICHARD LEMIEUX, KIPAWA (CA)

(21) Appl. No.: 18/860,962

(22) PCT Filed: May 1, 2023
(86) PCT No.: PCT/CA2023/050582

§ 371 Date: Oct. 28, 2024

Related U.S. Application Data
(60) Provisional application No. 63/363,967, filed on May 2, 2022.

(51) Int. Cl. H02H 3/32; F24H 1/54; F24H 9/20; H02H 5/04; H05B 1/02

(52) U.S. Cl. CPC H02H 3/32; H02H 5/042; H05B 1/0283; F24H 1/54; F24H 9/2071

(57) ABSTRACT

Spa systems may be used all year round and in colder weather provide an enjoyable experience for users through the cold ambient outdoor temperature and the heated water of the spa. However, failures in respect of the water circulating pump and/or heater of the spa system either mechanically, electrically or through overall power outages mean the water in the spa system and its pipework can easily freeze if ambient conditions are cold enough leading to cracks in the spa system or pipes and hence leaks when the water thaws requiring costly repair or replacement of components or entire systems. Accordingly, a freeze protection system is provided that uses a backup thermal management system discretely or in combination with other backup systems. These freeze protection systems offering backup when mechanical failures, electrical failures etc. arise by providing thermal input to the spa system through alternate thermal paths and providing alarms.

### CROSS-REFERENCE TO RELATED APPLICATIONS

This patent application claims the benefit of priority as a 371 national phase entry application PCT/CA2023/050582 filed May 1, 2023; which itself claims the benefit of priority from U.S. Provisional Patent Application 63/363,967 filed May 2, 2022.

### FIELD OF THE INVENTION

This patent application relates to spa systems and more particularly to backup methods and systems for spa systems in environments where freezing is possible.

### BACKGROUND OF THE INVENTION

Spa systems, also known as hot tubs or Jacuzzis (the manufacturers name becoming synonymous with such products irrespective of manufacturer), have become increasingly popular. Spa systems may be used all year round and during the colder weather seasons provide an enjoyable experience to users with the contrast of the cold ambient outdoor temperature and the heated water of the spa. However, a significant portion of the spa systems are installed in locations where temperatures get to freezing or below. If the spa system is in a residential environment or will be used sporadically/periodically/frequently during the colder weather seasons then it is likely to be maintained in filled condition and kept in a “sleep” mode wherein the water is only heated during filter cycles. Some spa systems may provide limited low temperature protection and operate pumps at low speed for limited time to circulate the water through the system on the basis of expecting hot water in the tub and hence be drawn through the water system.

However, a known problem with spa systems in external environments, and occasionally indoor environments, is that a failure or power being cut off to the water circulating pump and/or heater of the spa system then the water in the spa system and in the pipework connected thereto can freeze leading to expansion of the water as it freezes causing cracks to form in the spa system or pipes and/or joints in the system to fail. These faults and any other damage from leaks etc. can require costly and/or time-consuming repair or replacement of components or entire systems.

The inventor has previously established, see World Patent Application WO/2019/03319“Backup Methods and Systems for Spa System Thermal Management”, methods and systems for freeze protection for spa systems using a backup thermal management system and/or backup systems. However, electrical elements in external environments and/or associated with water have additional requirements with respect to safety and protection of users of the spa system and/or others within the vicinity of the spa system. Accordingly, the inventor has established heaters and/or control interfaces for such thermal management systems compliant with these safety requirements.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to spa systems and more particularly to backup methods and systems for spa systems in environments where freezing is possible.

In accordance with an embodiment of the invention there is provided a heater system comprising:
a heater for coupling to an electrical mains comprising a power converter, a protection circuit, a fan and a heater element; and
a controller electrically coupled to the heater for receiving a power signal from the power converter and providing a control signal to the heater to enable or disable the heater via the protection circuit.

In accordance with an embodiment of the invention there is provided a heater system comprising:
an electrical cable coupled to the heater at a first end and having an electrical connector disposed at a second distal end for connection to an electrical mains;
a protection circuit coupled to the first end of the electrical cable and to a heater element;
a fan; and
the heater element; wherein
the electrical cable incorporates an in-line ground fault circuit interrupter (GFCI).

In accordance with an embodiment of the invention there is provided a heater system comprising:
an enclosure comprising:
a flexible sheet; and
a plurality of heater elements disposed in a predetermined pattern; and
the controller which electrically coupled to the plurality of heater elements to provide electrical signals to the plurality of heaters; wherein
the enclosure when disposed around a predetermined portion of a spa system heats another predetermined portion of the spa system via the electrical power heating the plurality of heaters.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a typical domestic spa system as sold commercially by retailers and original equipment manufacturers (OEMs) today;

FIG. 2 depicts the physical construction of a typical domestic spa system as sold commercially by retailers and OEMs today;

FIG. 3 depicts a backup system for a typical domestic spa system according to an embodiment of the invention;

FIG. 4 depicts a backup system for a typical domestic spa system according to an embodiment of the invention;

FIG. 5 depicts a heater according to an embodiment of the invention for use with a spa thermal management system;

FIG. 6 depicts a deployment configuration for a heater according to an embodiment of the invention for use with a spa thermal management system;

FIG. 7 depicts a configuration of controller, heater and temperature sensors according to an embodiment of the invention for use with a spa thermal management system;

FIG. 8 depicts an assembly of a controller according to an embodiment of the invention with the shell of a spa system;

FIG. 9 depicts an interconnection between a controller, heater and temperature sensors according to an embodiment of the invention for use with a spa thermal management system;

FIG. 10 depicts an attachment means for a heater according to an embodiment of the invention to a spa system;

FIG. 11 depicts perspective views of a heater according to an embodiment of the invention for mounting to a pipe of a spa system;

FIG. 12 depicts views of a heater according to an embodiment of the invention for mounting to a pipe of a spa system;

FIG. 13 depicts views of a heater according to an embodiment of the invention for mounting to a pipe of a spa system;

FIG. 14 depicts direct and adapted mounting of a heater according to an embodiment of the invention for mounting to a pipe of a spa system;

FIG. 15 depicts graphs of cavity air temperature and water pipe temperature during operation of a heater system according to an embodiment of the invention in protecting a spa system;

FIG. 16 depicts a block diagram for heater control connections for a heater according to an embodiment of the invention;

FIG. 17 depicts enclosures for spa systems according to embodiments of the invention;

FIG. 18 depicts a backup system for a spa system according to an embodiment of the invention;

FIG. 19 depicts a backup system for a spa system according to an embodiment of the invention;

FIG. 20 depicts a heater according to an embodiment of the invention for use with a spa thermal management system;

FIG. 21 depicts a deployment configuration for a heater according to an embodiment of the invention for use with a spa thermal management system;

FIG. 22 depicts a configuration of controller, enclosure, heater and temperature sensors according to an embodiment of the invention for use with a spa thermal management system;

FIG. 23 depicts a configuration of controller, enclosure, heater and temperature sensors according to an embodiment of the invention for use with a spa thermal management system; and

FIG. 24 depicts a handle for demountable attachment to a ratchet tie-down strap or straps according to an embodiment of the invention;

FIG. 25 depicts a handle for demountable attachment to an endless cam buckle style tie down according to an embodiment of the invention;

FIG. 26 depicts a configuration of controller and heater according to an embodiment of the invention;

FIG. 27 depicts a configuration of controller and heater according to an embodiment of the invention; and

FIG. 28 depicts a configuration of controller and heater according to an embodiment of the invention;

### DETAILED DESCRIPTION

The present invention is directed to spa systems and more particularly to backup methods and systems for spa systems in environments where freezing is possible.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting of” and grammatical variants thereof do not preclude the addition of one or more components, features, steps, integers, or groups thereof and that the terms are not to be construed as specifying components, features, steps, or integers. Likewise, the phrase “consisting essentially of,” and grammatical variants thereof, when used herein is not to be construed as excluding additional components, steps, features integers or groups thereof but rather that the additional features, integers, steps, components, or groups thereof do not materially alter the basic and novel characteristics of the claimed composition, device, or method. If the specification or claims refer to “an additional” element, that does not preclude there being more than one of the additional element.

“Mains” as used herein and throughout this disclosure, refers to “mains electricity,” this being the general-purpose alternating-current (AC) electric power supply delivered to homes and businesses. The two principal properties of the mains electrical power supply, voltage, and frequency, differ between regions. A voltage of (nominally) 230 V and a frequency of 50 Hz is used in Europe, most of Africa, most of Asia, much of South America and Australia. In North America, the most common combination is 120 V and a frequency of 60 Hz. Other voltages exist, and some countries may have, for example, 230 V but 60 Hz. Electrical mains is distributed by cabling and normally terminates with a socket installed upon a wall or other solid portion of a building to which an electrical device is connected by means of a plug and cable. Some devices are permanently connected to the electrical mains via a circuit breaker/fuse such as cookers, freezers, refrigerators, washing machines, tumble driers etc. Other devices are connected via plug-socket. Some electrical devices such as portable electronic devices (PEDs) may employ a plug-cable that has a plug at the end of the cable to connect/disconnect to the electrical mains at the device for portability. Such a cable may also typically include a power converter to convert the AC electrical mains to a direct current (DC) input to the PED. Plug and socket configurations vary by different regions and countries.

A “spa system” (also known as a hot tub or Jacuzzi) is a large tub or small pool full of heated water used for hydrotherapy, relaxation or pleasure and may include powerful jets as well as providing whirlpool functionality, bubble generation, or net water flow across the spa system to provide resistance to a user's motion such as swimming. A spa system is typically designed to be used by more than one person at a time and usually located outdoors, although they can be installed indoors.

A “spa tub” as used herein and throughout this disclosure, refers to a wide, open, deep, container with walls and a bottom within which the user(s) of the spa system sit, kneel, and/or lay. The geometry of the spa tub may be circular, elliptical, rectangular, square or another geometry whilst the walls and/or bottom of the spa tub may contain features including ledges, seats, spa jets, bubble generators, etc. Typically, a spa tub is formed from fiber glass although other materials may be employed. A spa tub may be a bath tub without spa jets etc., a spa, a hot tub, a Jacuzzi, swim spa, or a tub.

A “shell” as used herein and throughout this disclosure, refers to the external physical structure supporting the spa tub and providing an exterior casing providing a visually aesthetic exterior to the user whilst covering the pump, heater, piping, manifolds, auxiliary pumps, etc. forming the spa pack and plumbing within the spa system.

A “fitting” as used herein and throughout this disclosure, refers to any machine component, piping or tubing part that can attach or connect two or more parts. Such fittings may include, but not be limited to, a coupling, couplings, compression fitting, pipe fitting, piping fittings, plumbing fittings, plumbing fitting, electrical connector.

A “mounting” as used herein and throughout this disclosure, refers to part of a device, system., ancillary, etc. which is configured to support and/or attach another device, system, ancillary, components etc. to said part of the device, system, ancillary, component etc. A mounting typically supports demountable attachment of the parts but may be employed in permanent attachment to define the location of the point of attachment or support demountable attachment prior to permanent attachment.

A “fixing” or “attachment means” as used herein and throughout this disclosure, refers to component, device, or means employed to permanently or demountably attach a device, system, ancillary, components etc. to part of another device, system, ancillary, component etc. This may include, but not be limited to, depending upon whether permanent or demountable and the material(s) being joined fasteners, glues, resins, epoxies, cementing, welding, soldering, brazing, pressure differentials, magnets, clamps, clips, ties, supports, physical retention elements such as clips and crimps, and physical retention methods such as friction and interference fit. Fasteners may include, but not be limited to, bolts, nuts, washers, screws, threaded fasteners, rivets, nails, pins, hook-and-eye, and hook and loop.

A “demountable” connection as used herein and throughout this disclosure, refers to component, device, or means employed to permanently or demountably attach an electrical connection or fluidic connection on a device, system, ancillary, components etc. to another electrical connection or fluidic connection on another device, system, ancillary, component etc. Electrical “demountable” connections are typically formed by plug and socket arrangements in discrete, linear array, or two-dimensional (2D) array formats or discrete male-female threaded connectors typically employed for microwave and RF. Fluidic “demountable” connections typically are formed by male-female threaded connectors with O-ring, sealing ring or gasket seals.

A “fluid” as used herein refers to a liquid, a gas, a mixture of liquids or a mixture of gases.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “user” as used herein may refer to, but is not limited to, an individual or group of individuals. This includes, but is not limited to, private individuals, employees of organizations and/or enterprises, members of community organizations, members of charity organizations, men, and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed, and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

A “battery” (formally an electric battery) as used herein may refer to, but is not limited to, a device consisting of one or more electrochemical cells with external connections provided to power electrical devices such as PEDs and FEDs When a battery is supplying electric power, its positive terminal is the cathode and its negative terminal is the anode. A battery may be a primary battery which is designed to be used until exhausted of energy and then discarded or a secondary battery which can be recharged after a full or partial discharge allowing them to be used, recharged, and used again multiple times. Common types of primary batteries may include, but are not limited to, zinc-carbon and alkaline. Common types of secondary batteries may include, but are not limited to, lead-acid, valve regulated lead-acid (VRLA, such as gel batteries or absorbed glass mat batteries), nickel-cadmium (NiCd), nickel-zinc (NiZn), nickel metal hydride (NiMH), and lithium-ion (Li-ion).

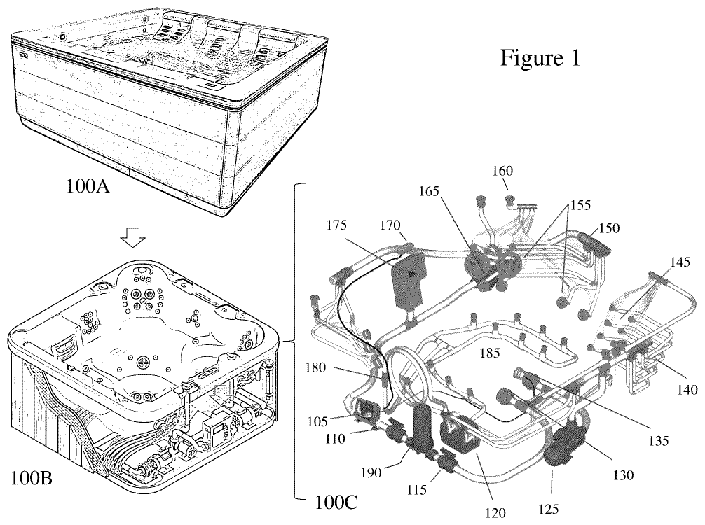

Referring to FIG. 1 there are depicted first to third images 100A to 100C with respect to a typical domestic spa system as sold commercially by retailers and original equipment manufacturers (OEMs) today. First image 100A depicts the spa system as bought and installed for a user whilst second image 100B depicts the spa system with the lower frame and shell removed. Third image 100C shows the spa system with the tub itself now removed thereby showing the mechanical elements and fluidic assemblies. Accordingly, there are depicted the following elements:
Control System 105;
Piping 110;
3-way Valves 115
Blower 120;
Massage Pump 125;
Suction Inlet 130;
Lights 135;
Hoses 140;
Back Jets 145; and
Manifolds 150.

Also depicted are:
Massage Jets 155;
Air Controls 160;
Circulation Pump 165;
Control Panel (for user) 170;
Skimmer 175;
Check Valve 180;
Air Jets 185; and
Water Heater 190.

The powered components of a spa include a water heater 190, at least one pump (Circulation Pump 165) for circulating water through pipes interconnecting the Water Heater 190 and the tub, and a controller (Control System 105) operable to control the Circulation Pump 165 (and Massage Pump 125) and the Water Heater 190 in response to input from an owner, operator, or user of the spa. Collectively, these components are often referred to as a spa pack. The spa pack is typically connected to a main electrical power source through a cable to a ground fault circuit interrupter (GFCI), which will disconnect electrical communication between the spa pack and the power source if a ground fault is detected in order to remove a potential electrocution hazard to the user(s). This is problematic during winter use of the spa, in that if the GFCI cuts off the power supply to the spa pack and the spa system is left unattended, the water can quickly freeze, especially in the circulation pipes, pump(s), heater, distribution manifold(s) and cause damage to the spa. Operating spas are sometimes left unattended for extended periods of time during the cold weather season, for example by cottage owners who transit back and forth between a rural cottage and an urban environment and leave their cottage spa running between visits during the winter season to prevent freezing. Should the GFCI trip in their absence, they will likely return to find their spa frozen when the next retreat to the cottage.

Alternatively, the mains power may fail as the GFCI may not trip but a circuit breaker at an internal mains distribution panel may trip removing power. In other scenarios the Water Heater 190 may fail, the Circulation Pump 190 stall or fail, or the piping/skimmer may be come blocked through debris if a cover is incorrectly applied or not applied at all. Of course, an inadvertent disconnection of the electrical cabling to the spa system may also occur in some circumstances as well as blown fuses, pumps seizing, heater failures, power surges etc.

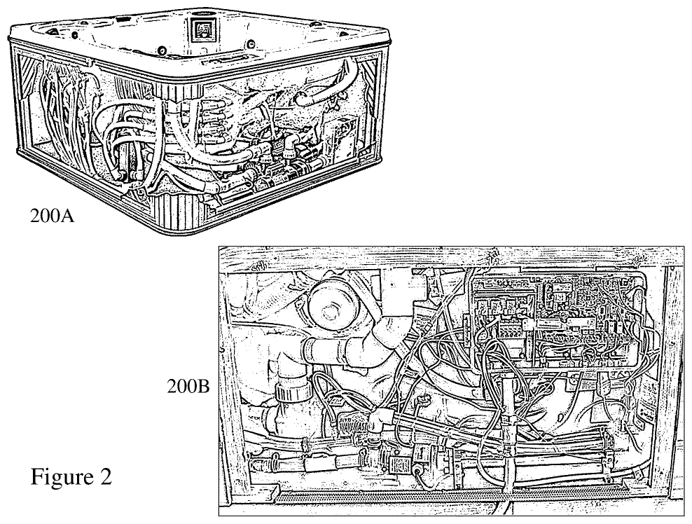

Now referring to FIG. 2 there are depicted first and second images 18A and 18B with respect to the physical construction of a typical domestic spa system as sold commercially by retailers and OEMs today such as that described and depicted in respect of FIG. 1 and first to third image 100A to 100C, respectively. As evident, the spa pack, controller and the piping etc. are fitted within a shell that is not much larger than the actual tub itself so that additional space between the tub lining and the outer shell is not massive.

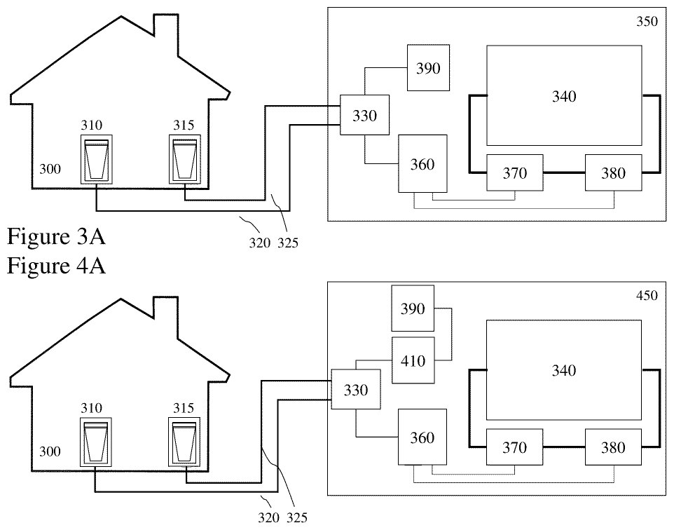

Accordingly, in order to establish a system with improved tolerance to a wider variety of fault mechanisms the inventor has established a different design methodology in respect of spa systems. Referring to FIG. 3, there is depicted a backup system for a typical domestic spa system according to an embodiment of the invention. Accordingly, as depicted a first GFCI 310 couples a first electrical cable 320 to a first part of an Electrical Connector 330 whilst a second GFCI 315 couples a second electrical cable 325 to a second part of the electrical connector 330. The first part of the Electrical Connector 330 is coupled to the Controller 360 which is coupled to Pump 370 and Heater 380 and accordingly functions in a manner similar to that depicted in respect of FIG. 4 and the prior art. The second part of the Electrical Connector 330 is coupled to Auxiliary Heater 390 which by virtue of the second electrical cable 325 and second GFCI is coupled to a different electrical supply than that powering the Pump 370 and Heater 380. Optionally, the first and second electrical circuits may be routed through different electrical connectors rather than a single Electrical Connector 330. The Auxiliary Heater 390 may be a forced air electrical heater which heats the region between the lower surface of the Tub 340 and the outer shell of the Spa System 350. In the event of a detection of a failure of the first electrical circuit within some embodiments of the invention and/or detection of a temperature within the spa system below a predetermined threshold temperate (set point temperature) then the second electrical circuit is engaged.

A low complexity approach is to employ a secondary circuit and/or Auxiliary Heater 390 which includes a thermostat (not depicted for clarity) set for, say 40° F. (approximately 5° C.) then the Auxiliary Heater 390 will turn on automatically when the detected temperature drops to below 40° F. Accordingly, the Auxiliary Heater 390 will operate irrespective of whether the first electrical circuit is live or dead and if live whether the Pump 370 and Heater 380 are functioning. Optionally, rather than an electrical thermostat providing a control signal to the Auxiliary Heater 390 may be coupled to the second electrical circuit via one or more mechanical temperature switches exploiting, for example, bimetallic elements to make the electrical connections or cause a conductive fluid to make the contact (e.g., mercury). Alternatively, a mechanical switch based upon mechanical expansion/contraction with temperature may be employed, such as a so-called “snap disc” or “snap-action” thermostat may be employed. Optionally, the first electrical circuit may be disconnected through mechanical temperature dependent switches such that the Heater 380 and/or Pump 370 are disconnected discretely or in combination with the Controller 360.

Optionally Electrical Connector 330 rather than a single housing with dual electrical interfaces may be a pair of discrete electrical connectors each being a discrete electrical interface (e.g., a plug or socket).

Now referring to FIG. 4 there is depicted a Spa System 450 according to an embodiment of the invention. As depicted the physical configuration is essentially identical to that depicted in FIG. 3A with the exception of the addition of a Battery Backup 410 disposed within the second electrical circuit prior to the Auxiliary Heater 390. Battery Backup 410 may, for example, be a primary battery designed to be replaced after use or a secondary battery designed to be recharged and to maintain charge through a so-called “trickle” charging process. In the event of a detection of a failure of the first electrical circuit within some embodiments of the invention and/or detection of a temperature within the spa system below a predetermined threshold temperate (set point temperature). Accordingly, considering a thermostat initiated powering of the Auxiliary Heater 390 then upon detection of a temperature below the set point temperature of the thermostat the thermostat couples the Auxiliary Heater 390 to the first electrical circuit which now includes the Battery Backup 410. Accordingly, if the second electrical circuit is active then the Auxiliary Heater 390 operates from the electrical mains but in the event of a failure to the second electrical circuit (e.g., a power failure (commonly referred to as a power cut) the Battery Backup 410 provides electrical power to the Auxiliary Heater 390.

It would be evident that systems exploiting Battery Backup 410 may provide protection even in the event of a triggering of a main circuit breaker associated with the spa system, multiple circuit breakers associated with the spa system, and the mains power feed to the spa system and/or its associated property etc. failing (e.g., power cut).

As the Auxiliary Heater 390 is intended to maintain a temperature sufficiently above freezing to protect the fluidic system, comprising Tub 340 and ancillary elements such as Piping 110, Jets Hoses 140, Back Jets 145, and Manifolds 150 as depicted in FIG. 1, rather than heat the water for use of the Tub 340 the power requirements are significantly reduced. Further, the overall volume of air being heated is relatively small as evident from FIG. 2 and first and second images 18A and 18B. It would be evident that the addition of insulation to the exterior walls of the Spa System 450 may be beneficial to further reduce heat loss both initially and during operation of the Auxiliary Heater 390. Likewise, exploiting higher quality coverings including those commonly referred to as “solar covers” or “solar blankets” to exploit available sunlight may further either delay the onset of powering the Auxiliary Heater 390 or the length of time the Auxiliary Heater 390 can operate.

Within other embodiments of the invention according to the design of the Spa System 450 the Auxiliary Heater 390 discretely or in combination with Battery Backup 410 may be a feature of the Spa System 450 when purchased by the user or alternatively added subsequently as an upgrade or retrofit option for the user. In either instance the Auxiliary Heater 390 and/or Battery Backup 410 may be designed in conjunction with the Spa system 450 to fit within the cavity of the Spa system 450 between the Tub 340 and the outer shell of the Spa system 450. Alternatively, the Auxiliary Heater 390 and/or Battery Backup 410 may be designed in conjunction with the Spa system 450 to be provided as an additional housing with a duct and/or opening between the additional housing and the cavity beneath the Tub 340. With a separate Auxiliary Heater 390 and an insulated ducted connection between the Auxiliary Heater 390 and the Spa System 450 options for powering the Auxiliary Heater 390 increase to include, for example, a propane gas based heater, a diesel generator based heater, petrol generator based heater, etc. The Auxiliary Heater 390 may be a forced air heater, an electrical element heater, a wound tape electrical heater, a heat lamp, an infrared heat lamp, etc. Alternatively, the Battery Backup 410 may be replaced with a generator to provide electrical power to the Auxiliary Heater 390 wherein the generator is engaged based upon a thermostat within the chamber of the Spa system 450 or within the fluidic system of the Spa system 450 for example. Such a generator may, for example, exploit a fuel such as oil, gasoline, or diesel.

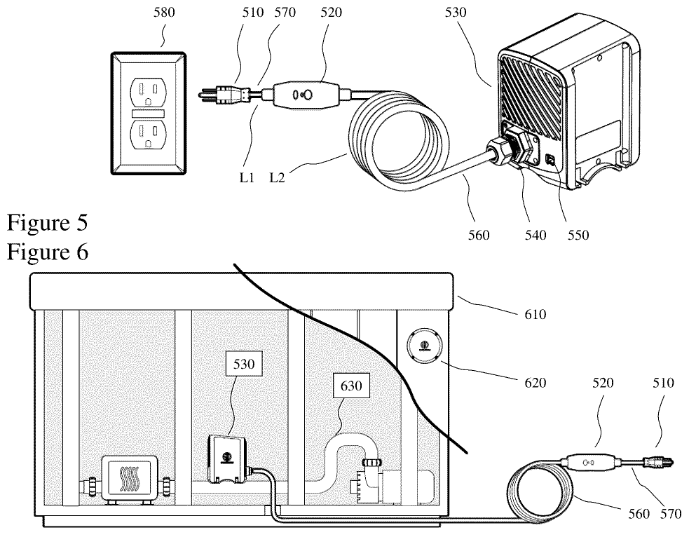

Now referring to FIG. 5 there is depicted a Heater 530 according to an embodiment of the invention for use with a spa thermal management system. As depicted the Heater 530 comprises a Mains Electrical Port 540 which is connected to a first Cable 560 and therein to an Inline GFCI 520, a second Cable 570 and an Electrical Plug 510. The Main Electrical Port 540 “hard wires” the Heater 530 to the first Cable 560 although within other embodiments of the invention the Heater 530 may be connected to the first Cable 560 via a demountable connector if local electrical regulations allow.

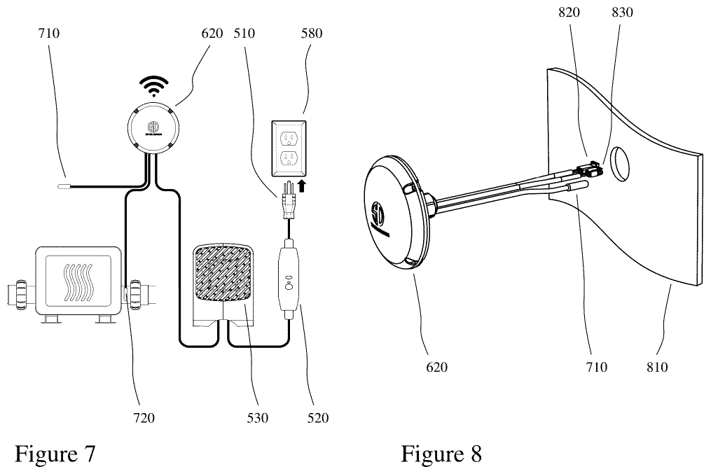

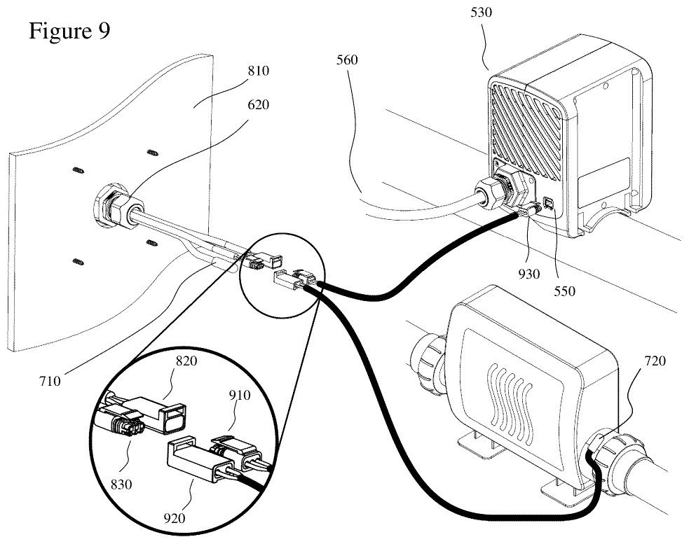

The Electrical Plug 510 for connection to a GFCI Socket 580, such as first GFCI 310 or second GFCI 315 in FIGS. 3 and 4 for example, such as on the outer wall of a building or property. The GFCI Socket 580, may for example, be separate from a GFCI and electrical connection for the spa system (not depicted for clarity) such that triggering of the GFCI for the spa system due to a fault does not automatically disrupt power to the Heater 530. Accordingly, the In-Line GFCI 520 allows the Heater 530 to be connected also to a non-GFCI socket rather than a GFCI Socket 580. Optionally, the mating of the Electrical Plug 510 and GFCI Socket 580 which is depicted as male connector (on Electrical Plug 510) to female socket (on GFCI Socket 580) may be reversed to female socket (on Electrical Plug 510) to male connector (on GFCI Socket 580) or other configurations via an intermediate adapter. Also depicted on the Heater 530 is a Control Port 550 as described and/or depicted below in respect of FIGS. 7 and 9.

The In-Line GFCI 520 allows for the Heater 530 to comply, in some deployment scenarios, with regulatory requirements. The length of the first Cable 560 deployed from the location of the In-Line GFCI 520 to Heater 530 may be sufficient to prevent a user reaching both simultaneously or concurrently such that in the event of the In-Line GFCI 520 tripping the user cannot be in contact with the Heater 530 and reset the In-Line GFCI 520. In other instances, the length of the first Cable 560 deployed from the location of the In-Line GFCI 520 to the nearest point on the spa system may be defined to prevent a user reaching both simultaneously or concurrently.

Accordingly, the In-Line GFCI provides ground fault protection and/or circuit interruption of the electrical power to the Heater 530. As depicted the length of the second Cable 570 between the Electrical Plug 510 to the In-Line GFCI 520 is L1 and the length of the first Cable 560 between the In-Line GFCI 520 and the Heater 530 is L2. The lengths L1 and L2 or a total length L1+L2 may be defined by one or more of a local electrical regulatory requirement, a manufacturer of the heater system, and an installer of the heater system. Optionally, L2 may be adjusted by a qualified electrical technician removing the first Cable 560 from the Heater 530 at Main Electrical Port 540 and extending/shortening the first Cable 560 and re-connected to the Main Electrical Port 540.

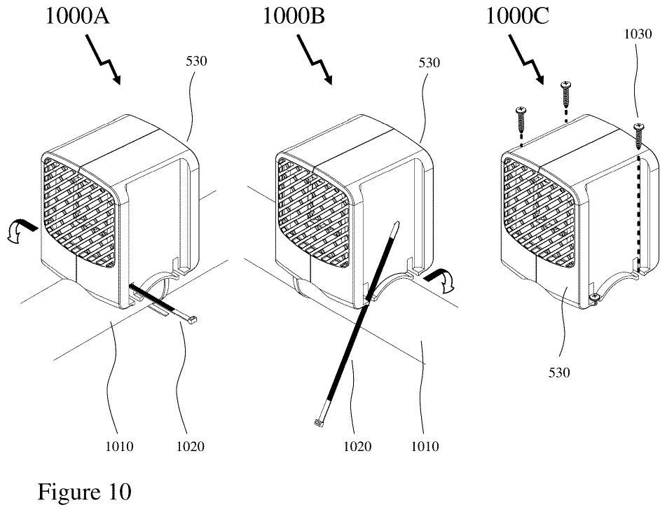

Referring to FIG. 6 there is depicted a deployment configuration for a Heater 530 according to an embodiment of the invention with a Spa 510 to provide a spa thermal management system according to an embodiment of the invention. As depicted the Heater 530 again comprises the first Cable 560, Inline GFCI 520, the second Cable 570 and Electrical Plug 510. As depicted in FIG. 6 the Heater 530 is mounted onto a Pipe 630 of the Spa 610 as described, for example, with respect to FIGS. 10 to 13, respectively. Also mounted to the Spa 610 is Controller 620 which may, for example, provide a visual indication of the operation state of the spa thermal management system as well as a wireless interface for pushing status data relating to the spa thermal management system to a remote electronic device and/or receiving control data etc. from another remote electronic device.

Now referring to FIG. 7 depicts a configuration of controller, heater, and temperature sensors according to an embodiment of the invention for use with a spa thermal management system. The Heater 530 is connected in common with FIGS. 5 and 6 to an In-Line GFCI 520 and 510 for connecting to GFCI Socket 580 (or other electrical power interface). The Heater 530 is also connected to Controller 620. Controller 620 being coupled to first and second Temperature Sensors 710 and 720, respectively. First Temperature Sensor 710 provides for monitoring the temperature of the cavity of the spa system the Heater 530 is deployed within whilst second Temperature Sensor 720 provides for monitoring of the temperature of the piping of the spa system (and thereby the water temperature).

Now referring to FIG. 8 there is depicted an assembly of a Controller 620 according to an embodiment of the invention with the Shell 810 of a spa system wherein the electrical connections from the Controller 620 are fed through the Shell 810 of the spa system. However, it would be evident that within other embodiments of the invention the electrical connections from the Controller 620 may be fed down the side of the Shell 810 of the spa system and underneath before being routed within the spa system. As depicted, the Controller 620 as a first Electrical Connector 820 for connecting the Controller 620 to a control port of the heater, e.g., Control Port 550 of Heater 530 as depicted in FIG. 5. The Controller 620 also comprises a second Electrical Connector 830, for connecting the Controller 620 to the second Temperature Sensor 720 as depicted in FIG. 9, and the first Temperature Sensor 710 which is hard wired to the Controller 620. Optionally, both the first and second Temperature Sensors 710 and 720 respectively may be hard wired to the Controller 620. Optionally, the first Temperature Sensor 710 may also be connected via an additional connector to the Controller 620 or alternatively, the second Temperature Sensor 720 may be hard wired and the first Temperature Sensor 710 connected via a connector. Provisioning of wired connections between the first and second Temperature Sensors 710 and 720 respectively and the Controller 620 prevents issues with batteries for wireless temperature sensors connected to the Controller 620.

Referring to FIG. 9 there is depicted an interconnection between a Controller 620, disposed on the outer surface of the Shell 810 of the spa, the Heater 530 and the second

Temperature Sensor 720 which is attached to the fluidic system of the spa. Accordingly:
First Electrical Connector 820 of the Controller 620 is connected to first Control Interface 910 wherein the second Control Interface 920 of this interconnection is coupled to the Control Port 550 of the Heater 530; and
Second Electrical Connector 830 of the Controller 630 is connected to Temperature Connector 920 which is connected to the second Temperature Sensor 720.

Whilst in FIGS. 7 and 9 the second Temperature Sensor 720 is depicted as connected to a pipe section of a powered element of the spa, e.g., water heater or pump, the second Temperature Sensor 720 may be mounted to any suitable pipe within fluidic system of the spa.

Now referring to FIG. 10 there are depicted first to third Images 1000A to 1000C respectively of an attachment means for a heater according to an embodiment of the invention to a spa system. Accordingly:
First Image 1000A depicts the Heater 530 being attached to a Pipe 1010 via a Tie 1020 (e.g., cable tie) where the Tie 1020 is fed through a slot or slots of the shell of the Heater 530;
Second Image 1000B depicts the Heater 530 being attached to a Pipe 1010 via a Tie 1020 (e.g., cable tie) where the Tie 1020 is fed through a slot or slots on the outer edge of shell of the Heater 530 but the Tie 1020 does not go through the Heater 530; and
Third Image 1000C wherein the Heater 530 is attached via Screws 1030 to shell, base, wall, or another element of the spa.

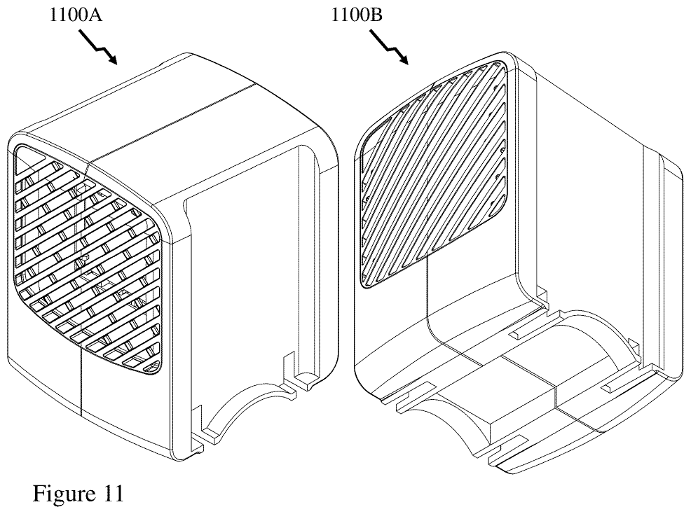

Referring to FIG. 11 there are depicted first and second perspective views 1100A and 1100B of a heater according to an embodiment of the invention for mounting to a pipe of a spa system. As depicted in FIG. 11 the heater supports the attachment means of first to third Images 1000A to 1000C in FIG. 10 where the base of the heater has a profile allowing it to mount to a circular pipe such that the forced air from the heater is blown on an axis perpendicular to the pipe to which the heater is attached.

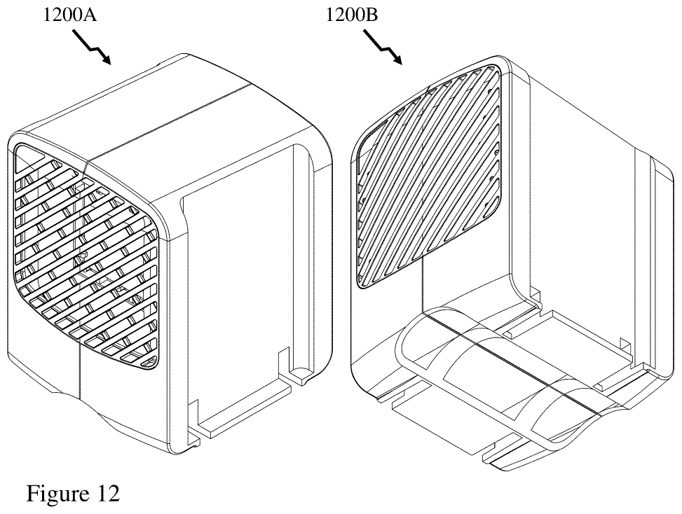

Now referring to FIG. 12 there are depicted first and second perspective views 118A and 118B views of a heater according to an embodiment of the invention for mounting to a pipe of a spa system. As depicted in FIG. 12 the heater supports the attachment means of first to third Images 1000A to 1000C in FIG. 10 where the base of the heater has a profile allowing it to mount to a circular pipe such that the forced air from the heater is blown along the same axis as that of the pipe to which the heater is attached.

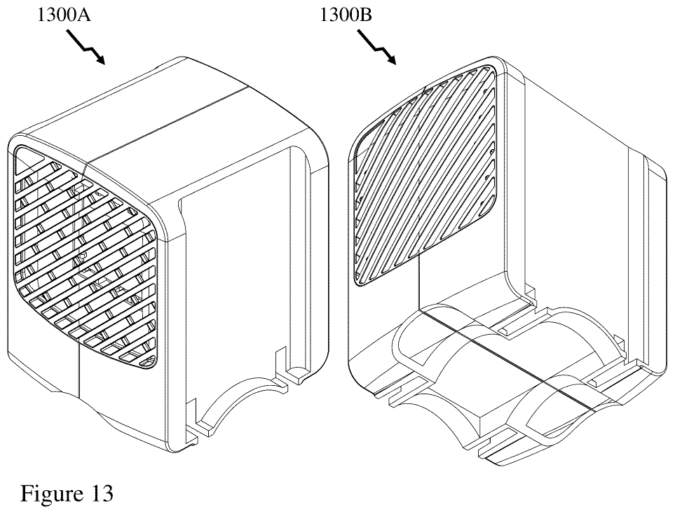

Referring to FIG. 13 there are depicted first and second perspective views 1300A and 1300B views of a heater according to an embodiment of the invention for mounting to a pipe of a spa system. As depicted in FIG. 13 the heater supports the attachment means of first to third Images 1000A to 1000C in FIG. 10 where the base of the heater has a profile allowing it to mount to a circular pipe in either of the configurations depicted in FIGS. 11 and 12 such that the forced air from the heater can be blown either on an axis perpendicular to the pipe to which the heater is attached or along the same axis as the pipe to which the heater is attached.

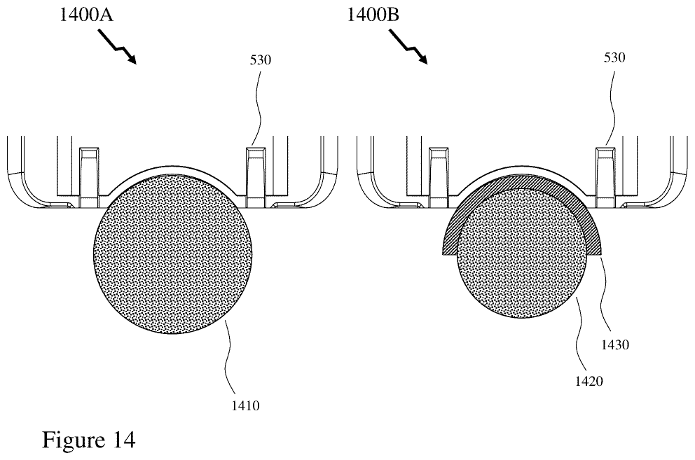

For example, the lower recess(es) on the heaters in FIGS. 11 to 13 may be dimensioned to support direct mounting to a pipe of a spa system such as depicted in first Image 1400A in FIG. 14, e.g., the lower recesses may be dimensioned for a 3″ (75 mm) internal diameter (ID) Pipe 1410 for example (i.e., outer diameter of 3.5″ (89 mm)). Alternatively, an Adapter 1430 may allow for the same heater designed to mount to 3″ ID piping to mount to a smaller ID Pipe 1420, e.g., a 1.5″ or 2″ ID pipe with outer diameters 1.9″ (48 mm) and 2.375″ (60 mm). Optionally, the Adapter 1430 may for formed from a resilient material, e.g., acrylonitrile butadiene styrene (ABS) or poly-vinyl chloride (PVC), or it may be formed from a compliant material, e.g., a polyurethane foam, allowing the Adapter 1430 to be compressed during attachment to accommodate either different pipe sizes or fitting etc. of the piping at the location of attachment.

A heater, e.g., Heater 530, and its associated controller, e.g., Controller 1620, may support one or more operational modes. For example, a normal operational mode may be supported. However, the heater/controller combination may also support a forced heat mode and/or a special heater test mode.

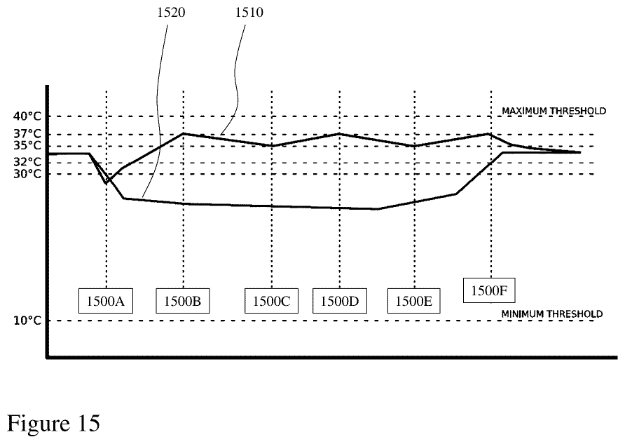

Within the following description with respect to FIG. 15 the temperatures defined for the different thresholds, set points etc. are exemplary values. It would be evident that other values for these thresholds, set points etc. may be employed without departing from the scope of the invention.

For example, within the normal operation mode the controller continually monitors the temperature of the spa system's plumbing (e.g., via second Temperature Sensor 720 in FIG. 7), the air temperature in a cavity below the spa system (via first Temperature Sensor 710 in FIG. 7), and the temperature of the controller which as depicted in FIGS. 6 and 8 is on the outside of the spa system and accordingly is at a temperature close to the outside air. The temperature sensor within the controller may be exposed to the outside air rather than being within the shell of the controller. In this mode the spa system's owner can set the threshold for detecting a fault condition between a lower limit, e.g., 10 degrees Celsius (50 degrees Fahrenheit) and an upper limit, e.g., 40degrees Celsius (104 degrees Fahrenheit) or the controller may exploit default factory settings for the lower and upper limits.

Accordingly, if the water temperature measured on the pipe drops below the set threshold, the controller will enable the heater. If the temperature rises and exceeds the set threshold by some threshold margin (e.g., 2 degrees Celsius/3.6 degrees Fahrenheit), the controller within the controller disables the heater.

Additionally, the heater may be disabled by the controller any time the air temperature in the cavity as monitored exceeds another preset or set limit (e.g., 37 degrees Celsius (98.6 degrees Fahrenheit)) and re-enabled again if it drops below a further preset or set limit (e.g., 35 degrees Celsius (95 degrees Fahrenheit)).

Now referring to FIG. 15 there are depicted graphs of cavity air temperature 1510 and water pipe temperature 1520 during operation of a heater system according to an embodiment of the invention in protecting a spa system. Within the scenario depicted the minimum threshold was set to 10 degrees Celsius (50 degrees Fahrenheit) and the maximum threshold set to 40 degrees Celsius (104 degrees Fahrenheit) are depicted together with the additional another preset of 37 degrees Celsius (98.6 degrees Fahrenheit) and further preset 35 degrees Celsius (95 degrees Fahrenheit). Also depicted is the set threshold of 30 degrees Celsius (86 degrees Fahrenheit) and its resulting threshold margin of 32 degrees Celsius (89.6 degrees Fahrenheit).

Accordingly, in FIG. 15, there are depicted first to sixth Decision Points 1500A to 1500F respectively, denoting different decision points within the control of the heater according to an embodiment of the invention. These being:
First Decision Point 1500A wherein the monitored pipe temperature drops below the threshold of 30 degrees Celsius (86 degrees Fahrenheit) wherein the heater turns on;
Second Decision Point 1500B wherein the monitored cavity temperature hits the another preset of 37 degrees Celsius (98.6 degrees Fahrenheit) wherein the heater turns off;
Third Decision Point 1500C wherein the monitored cavity temperature drops below the further preset of 35 degrees Celsius (95 degrees Fahrenheit) but as the pipe temperature is still below still low 30 degrees Celsius (86 degrees Fahrenheit) the heater turns on;
Fourth Decision Point 1500D wherein the monitored cavity temperature again hits the another preset of 37 degrees Celsius (98.6 degrees Fahrenheit) wherein the heater turns off again;
Fifth Decision Point 1500E wherein the monitored cavity temperature drops below the further preset of 35 degrees Celsius (95 degrees Fahrenheit) but as the pipe temperature is still below still low 30 degrees Celsius (86 degrees Fahrenheit) the heater turns on;
Sixth Decision Point 1500F wherein the monitored pipe temperature has risen above the threshold margin of 32 degrees Celsius (89.6 degrees Fahrenheit) relative to the set threshold of 30 degrees Celsius (86 degrees Fahrenheit) and the heater turns off.

Within an embodiment of the invention the minimum threshold, maximum threshold and the set threshold may be updated at any time by an owner of the spa system through data transmitted to the controller wirelessly from an electronic device associated with the owner either directly or through an intermediate server.

Within an embodiment of the invention the minimum threshold, maximum threshold and the set threshold may be updated at any time by a manufacturer of the spa system or a service provider associated with the manufacturer of the spa system through data transmitted to the controller wirelessly from an electronic device associated with the owner either directly or through an intermediate server.

Alternatively, the minimum threshold and maximum threshold may be set by the manufacturer of the spa system and the set threshold may be set the owner of the spa system.

The forced heat mode for a heater according to an embodiment of the invention may be established via the controller for certain circumstances such as performing maintenance work in the winter months for example. In this forced heat mode, the heater is forced to turn on for a period of time, either predetermined, set by the manufacturer of the spa system for example, or set at that point in time, by a service technician working on the spa system, for example until either a predetermined time limit is reached or the forced heat mode is turned off. Within an embodiment of the invention the forced heat mode may be triggered by sending an override command to the controller, for example from a server directly or via a wireless interface of an electronic device. Optionally, the settings for the controller may be pushed from a remote server or periodically obtained by the controller from polling the remote server. In these instances, the settings for a specific controller associated with a specific spa system may be updated upon the remote server wherein they are either pushed to the controller from the remote server or provided to the controller upon the controller next polling the remote server.

Within an embodiment of the invention the forced heat mode, also referred to by the inventor, as a forced heat override, may be disabled if the monitored cavity temperature exceeds the another preset of 37 degrees Celsius (98.6 degrees Fahrenheit). Within an embodiment of the invention the predetermined time limit for the forced heat mode may be 1 hour or 2 hours for example. If the predetermined time limit is reached then the forced heat mode may be re-triggered or only re-triggered after another time limit has expired, e.g., 15 minutes, 30 minutes, 1 hour for example.

The special heater test mode for a heater according to an embodiment of the invention may be established via the controller for certain circumstances such as performing maintenance work in the summer months for example. Within the special heater test mode, the controller enables the heater to turn on even if the monitored cavity air temperature is above the another preset of 37 degrees Celsius (98.6 degrees Fahrenheit) (or whatever it is set to). Accordingly, if the special heater test mode enable signal is received by the controller, then it drives the logic level for the heater control signal to the on state for another predetermined time limit, for example 2 minutes, 5 minutes, 15 minutes, or an hour. Once the another predetermined time limit has been reached then the controller turns off the heater. For example, the special heater test mode allows a service technician or an owner of the spa system for example to determine whether the heater/controller are functional and/or enabling service work to be performed. In the former instance of simply determining functional or not the another predetermined time limit may be a few minutes to briefly enable the heater allowing for the technician/owner etc. to listen for the sound of the heater fan.

Within embodiments of the invention the controller is not responsible for providing heater safety functions, rather these are provided by employing components that are compliant with the appropriate regulatory requirements in the country the heater is being employed within, such as Underwriters Laboratory (UL) in the United States, Canadian Standards Authority (CSA) in Canada, or CE marking (Europe) for example.

Within another embodiment of the invention an enclosure may comprise a shell and support the flow of heated air into the enclosure from a forced air heater. Optionally, the forced heated air may be simply fed into the enclosure or it may be fed in and recirculated back to the forced air heater. The forced air heater may be attached to the enclosure when purchased or it may be attached subsequently where the forced air heater may be sold with the enclosure or sold separately. The shell may be formed from a resilient material such that it does not expand beyond a predetermined point when “inflated” with the forced heated air. Alternatively, the shell may be elastic and employed within an outer shell formed from a resilient material. Optionally, the shell may be elastic and have an outer shell formed from a resilient material disposed on one side such that the outer shell is uppermost when the enclosure is employed. Optionally, the shell may be formed from a lower sheet which is elastic and an upper sheet which is resilient. Optionally, a resilient portion of the shell or outer shell may be shaped such that the enclosure fits over a spa system or series of spa systems.

Optionally, the forced air heater may be a forced air heater such as described within World Intellectual Property Office Patent Application WO2019033195 filed Aug. 16, 2018 (with priority to U.S. Provisional Patent Application 62/546,088 filed Aug. 16, 2017) and U.S. Provisional Patent Application 63/263,967 filed Apr. 29, 2022, by the inventor. Optionally, the forced air heater associated with the enclosure may be the forced air heater associated with a freeze protection system such as described within these two patent applications.

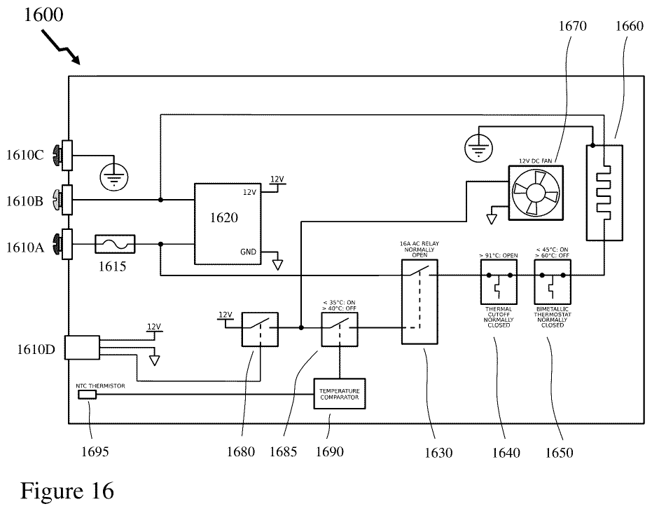

Referring to FIG. 16 there is depicted Block Diagram 1600 for heater control connections for a heater according to an embodiment of the invention. Electrical power is provided via AC Line Terminal 1610A and AC Neutral 1610B connections with Safety Ground 1610C. The AC Line Terminal 1610A and AC Neutral 1610B are connected to an AC/DC Converter 1620 via a Fuse 1615, e.g., a 10 A fuse. The AC Line Terminal 1610A is also connected to first Relay 1630 which is a normally open relay where the output of the first Relay 1630 is coupled via first Thermal Cutoff 1640 and second Thermal Cutoff 1650 to a Heater Element 1660 and therein back to the AC Neutral 1610B. First Thermal Cutoff 1640 is a normally closed temperature dependent switch that opens if the temperature exceeds a first Temperature Limit, e.g., 91 degrees Celsius (196 degrees Fahrenheit). Second Thermal Cutoff 1650 is a normally closed temperature dependent switch that open if the temperature exceeds a second Temperature Limit, e.g., 60 degrees Celsius (140 degrees Fahrenheit) and closes again when the temperature drops below an Offset Temperature from the second Temperature Limit, e.g., the Offset Temperature being for example 15 degrees Celsius (27 degrees Fahrenheit), such that the second Thermal Cutoff 1650 resets below 45 degrees Celsius (113 degrees Fahrenheit).

Second Thermal Cutoff 1650 may, for example, be a bimetallic thermostat. The second Thermal Cutoff 1650 being, for example, disposed close to the Heater Element 1660 with good thermal path to the Heater Element 1660 directly or through air flow induced by the Fan 1670. As depicted, the Fan 1670 is a 12V fan enabled through the second Relay 1680. Alternatively, the Fan 1670 may be DC driven at a different voltage, generated from the AC/DC Converter 1620 or another AC/DC Converter or AC driven at the line voltage coupled to the AC Line Terminal 1610A and AC Neutral 1610B or another AC voltage generated by an intermediate transformer.

The Heater Element 1660 may, for example, be an 800 W positive temperature coefficient (PTC) heater element formed from one or more ceramic materials. Alternatively, within other embodiments of the invention it may be a resistance wire, such as nichrome (Ni/Cr), kanthal (FeCrAl), cupronickel (CuNi) for example. Alternatively, within other embodiments of the invention it may be a ceramic or semiconductor-based element such as those employing molybdenum disilicide (MoSi2), silicon carbide (SiC), silicon nitride (Si3N4) or quartz halogen infrared heaters. These may be formed from one or more wires, thin film heater element(s), thick film heater element(s) or combinations thereof.

First Thermal Cutoff 1640 may, for example, be a non-resettable thermal cutoff which is also disposed close to the Heater Element 1660.

The first Relay 1630 is coupled to the controller via Controller Connector 1610D and intermediate second Relay 1680 and third Thermal Cutoff 1685. The second Relay 1680 enables the connection of a power supply, e.g., a 12V power supply, to the first Relay 1630 via the third Thermal Cutoff 1685 which is enabled by a control signal from the controller via the Controller Connector 1610D. The 12V power supply being generated by the AC/DC Converter 1620. The third Thermal Cutoff 1685 is coupled to a Temperature Comparator 1690 that determines whether a temperature measured by a Temperature Sensor 1695 exceeds a predetermined threshold temperature or not. For example, this predetermined threshold temperature may, for example, be 40 degrees Celsius (104 degrees Fahrenheit) such that when the temperature measured by the Temperature Sensor 1695 exceeds 40 degrees Celsius (104 degrees Fahrenheit) the third Thermal Cutoff 1685 decouples the 12V power supply from the first Relay 1630 such that the first Relay 1630 opens. When the temperature drops below the predetermined threshold temperature by an offset, e.g., 5 degrees Celsius (9 degrees Fahrenheit), then the Temperature Comparator 1690 closes the third Relay 1630 such that the 12V power supply is coupled to the first Relay 1630 such that the first Relay 1630 closes and the AC power connectable to the Heater Element 1660 when the first Thermal Cutoff 1640 and second Thermal Cutoff 1650 are closed.

Accordingly, the Heater 1630 incorporates safety mechanisms to avoid the Heater 1630 from unduly heating up the air inside the spa system independent of the logic control level of the heater control signal from the Controller coupled to the Heater 1630 through the Controller Connector 1610D which is coupled to the second Relay 1680.

These operate independent of the self-regulating PTC element employed for the Heater Element 1660 in some embodiments of the invention. A PTC element is self-regulating by design as is its maximum temperature. As the PTC element gets hotter its resistance increases and accordingly the thermal power generated reduces for a fixed constant supply voltage, the PTC element cools, its resistance drops, and the power dissipated increases.

The safety mechanisms within the heater, for example Heater 530 in FIG. 5, override the control signal from the controller, e.g., Controller 620 in FIGS. 6-8, under predetermined conditions.
1) The Temperature Comparator 1690 monitors the temperature in the heater assembly at a location away from the Heater Element 1660 and disables the heater control relay, first Relay 1630, when the temperature exceeds 40 degrees Celsius (104 degrees Fahrenheit), for example, whilst the Temperature Comparator 1690 will reenable the heater again once the temperature falls below 35 degrees Celsius (95 degrees Fahrenheit) for example.
2) A resettable thermostat, second Thermal Cutoff 1650, cuts electrical power to the Heater Element 1660 when its temperature exceeds the second Temperature Limit, e.g. 60 degrees Celsius (140 degrees Fahrenheit) and closes again when the temperature drops below an Offset Temperature from the second Temperature Limit, e.g. the Offset Temperature being for example 15 degrees Celsius (27 degrees Fahrenheit), such that the second Thermal Cutoff 1650 resets below 45 degrees Celsius (113 degrees Fahrenheit) and electrical power to the Heater Element 1660 is restored.
3) A non-resettable thermal cut-off, first Thermal Cutoff 1640, permanently disables the electrical power supply to the Heater Element 1660 if its temperature exceeds a first Temperature Limit, e.g., 91 degrees Celsius (196 degrees Fahrenheit). Within the embodiments described here this is a non-resettable thermal cut-off on the basis that this first Temperature Limit would only be reached in the event of a fault within the heater. Optionally, the non-resettable thermal cut-off may be replaced with a manually resettable thermal cut-off such that once tripped a user must reset it to re-enable the heater. Optionally, the non-resettable thermal cut-off may be replaced with a resettable thermal cutoff such that if the temperature drops another limit it resets, e.g., 70 degrees Celsius (158 degrees Fahrenheit).

Within embodiments of the invention the controller, e.g., Controller 620 in FIGS. 6-8, monitors the ambient air temperature inside the spa system cavity and prevents it from exceeding another preset or set limit (e.g., 37 degrees Celsius (98.6 degrees Fahrenheit)). As described above if the controller, e.g., Controller 620 in FIGS. 6-8, loses control and leaves the heater enable signal on, then the other safety mechanisms will limit the maximum ambient air temperature inside the spa system cavity to a defined set point temperature, e.g., 50 degrees Celsius (122 degrees Fahrenheit). The first Relay 1630, the first Thermal Cutoff 1640, the second Thermal Cutoff 1650, second Relay 1680, and third Thermal Cutoff 1685 together or in different combinations of subsets of these elements comprise a protection circuit for the heater.

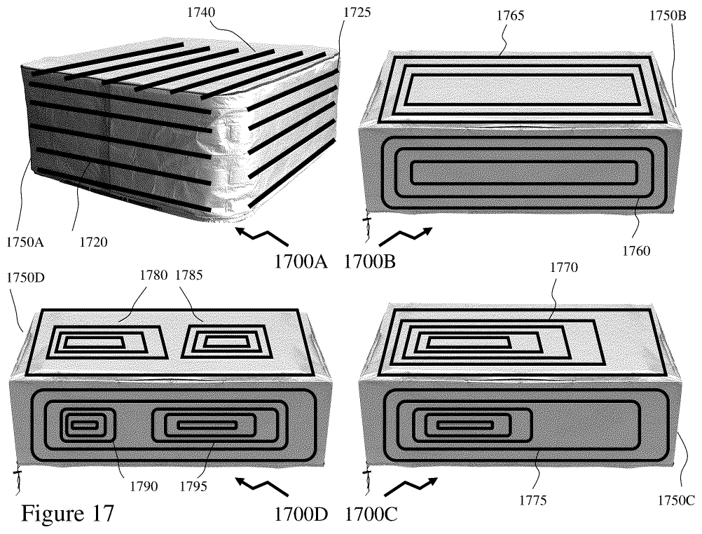

Now referring to FIG. 17 there are depicted first to fourth Images 1700A to 1700D respectively for use in conjunction with spa systems as sold commercially by retailers and OEMs today such as that described and depicted in respect of FIG. 1 and first to third images 100A to 100C, respectively.

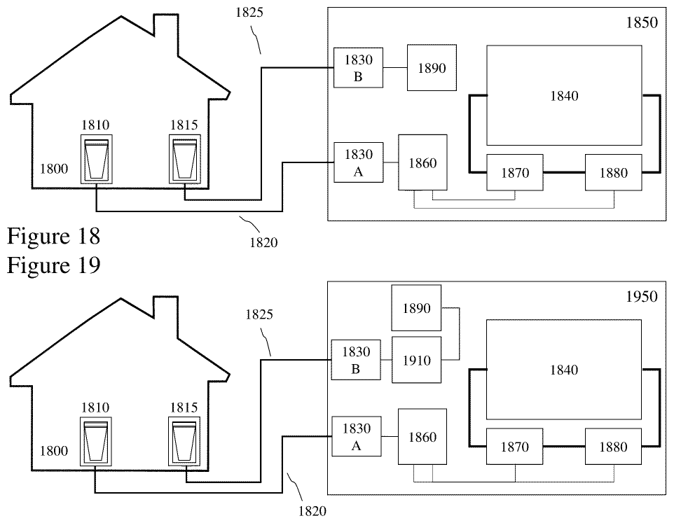

Referring to first Image 1700A there is depicted an Enclosure 1750A according to an embodiment of the invention disposed around a spa system as known in the art. Disposed within a top portion of the Enclosure 1750A are Upper Heating Elements 1740 whilst disposed within the sides of the Enclosure 1750A are first and second Side Heating Elements 1720 and 1725 respectively. As described and depicted below in respect of FIGS. 18 and 19 the Upper Heating Elements 1740 and first and second Side Heating Elements 1720 and 1725 respectively are coupled to a controller, not shown for clarity, which applies power to these heating elements in order to warm the inside of the Enclosure 1750A and therein the spa system disposed within. Optionally, within another embodiment of the invention a series of heating elements may be disposed upon the bottom of the Enclosure 1750A in addition to the top and sides. Whilst only two sides of Enclosure 1750A are depicted within embodiments of the invention heating elements may be disposed upon a single side, a pair of sides, or three or more sides of the Enclosure 1750A according to the design of the Enclosure 1750A and/or the spa system it is designed to provide warming to.

Now referring to second Image 1700B there is depicted an Enclosure 1750B according to an embodiment of the invention disposed around a spa system as known in the art. Disposed within a top portion of the Enclosure 1750B are Upper Heating Elements 1765 whilst disposed within the sides of the Enclosure 1750B are Side Heating Elements 1760. As described and depicted below in respect of FIGS. 18 and 19 the Upper Heating Elements 1765 and Side Heating Elements 1760 are coupled to a controller, not shown for clarity, which applies power to these heating elements in order to warm the inside of the Enclosure 1750B and therein the spa system disposed within. Optionally, within another embodiment of the invention a series of heating elements may be disposed upon the bottom of the Enclosure 1750B in addition to the top and sides. Whilst only one side of Enclosure 1750B is depicted within embodiments of the invention heating elements may be disposed upon a single side, a pair of sides, or three or more sides of the Enclosure 1750B according to the design of the Enclosure 1750B and/or the spa system it is designed to provide warming to.

The Upper Heating Elements 1740 and first and second Side Heating Elements 1720 and 1725 of Enclosure 1750A in first Image 1700A together with the Upper Heating Elements 1765 and Side Heating Elements 1760 of Enclosure 1750B are depicted as uniformly distributed. However, the number and spacing of the actual heating elements within a top, bottom or side of an enclosure such as Enclosures 1750A and 1750B in first and second Images 1700A and 1700B may be established may be established in dependence upon one or more factors. Such factors, may include, but not be limited to:
the shape of the spa system;
the positioning of one or more pumps of the spa system such as Massage Pump 125 and Circulation Pump 165 in FIG. 1 for example;
a layout of the piping and/or other fluid based elements of the spa system such as Piping 110, 3-way Valves 115, Blower 120, Suction Inlet 130, Hoses 140, Back Jets 145, Manifolds 150, Massage Jets 155, and Air Jets 185 for example in FIG. 1;
a status of one or more other heating elements associated with the spa system, such as Water Heater 190 for example in FIG. 1;
whether the enclosure is intended for storage, shipping, covering spa system in final user intended position, etc. discretely or a combination thereof;
the mechanical geometry of the spa system;
the geographical location and/or region for the spa system and thereby its anticipated temperatures during which the enclosure is expected to be employed; and
the location and performance of insulation within the outer shell of the spa system.

The Upper Heating Elements 270 and Side Heating Elements 275 of Enclosure 250B in third Image 200C are not uniformly distributed in contrast to those of Enclosures 210 and 250A in first and second Images 200A and 200B respectively. Within embodiments of the invention one or more of the number of, the spacing of, and the pattern of the heating elements may be established in dependence upon one or more factors. Such factors, may include, but not be limited to:
the shape of the spa system;
the positioning of one or more pumps of the spa system such as Massage Pump 125 and Circulation Pump 165 in FIG. 1 for example;
a layout of the piping and/or other fluid based elements of the spa system such as Piping 110, 3-way Valves 115, Blower 120, Suction Inlet 130, Hoses 140, Back Jets 145, Manifolds 150, Massage Jets 155, and Air Jets 185 for example in FIG. 1;
a status of one or more other heating elements associated with the spa system, such as Water Heater 190 for example in FIG. 1;
whether the enclosure is intended for storage, shipping, covering spa system in final user intended position, etc. discretely or a combination thereof;
the mechanical geometry of the spa system;
the geographical location and/or region for the spa system and thereby its anticipated temperatures during which the enclosure is expected to be employed; and
the location and performance of insulation within the outer shell of the spa system.

Referring to fourth Image 1700D there is depicted an Enclosure 1750D according to an embodiment of the invention disposed around a spa system as known in the art. Disposed within a top portion of the Enclosure 1750D are first and second Upper Heating Element Sets 1780 and 1785 whilst disposed within the sides of the Enclosure 1750D are first and second Side Heating Element Sets 1790 and 1795. As described and depicted below in respect of FIGS. 18 and 19 the first and second Upper Heating Element Sets 1780 and first and second Side Heating Element Sets 1790 and 1795 are coupled to a controller, not shown for clarity, which applies power to these heating elements in order to warm the inside of the Enclosure 1750D and therein the spa system disposed within. Optionally, within another embodiment of the invention a series of heating elements may be disposed upon the bottom of the Enclosure 1750D in addition to the top and sides. Whilst only one side of Enclosure 1750D is depicted within embodiments of the invention heating elements may be disposed upon a single side, a pair of sides, or three or more sides of the Enclosure 1750D according to the design of the Enclosure 1750D and/or the spa system it is designed to provide warming to.

As discussed above with respect to Enclosures 1750A-1750C in first to third Images 1700A to 1700C respectively the number and positioning of the heating element sets, such as first and second Upper Heating Element Sets 1780 and 1785 respectively or first and second Side Heating Element Sets 1790 and 1795 respectively may be established in dependence upon one or more factors. Similarly, the number of, the spacing of, and the specific pattern of the heating elements within each heating element set may be established in dependence upon one or more other factors. Such factors and other factors, may include, but not be limited to:
the shape of the spa system;
the positioning of one or more pumps of the spa system such as Massage Pump 125 and Circulation Pump 165 in FIG. 1 for example;
a layout of the piping and/or other fluid based elements of the spa system such as Piping 110, 3-way Valves 115, Blower 120, Suction Inlet 130, Hoses 140, Back Jets 145, Manifolds 150, Massage Jets 155, and Air Jets 185 for example in FIG. 1;
a status of one or more other heating elements associated with the spa system, such as Water Heater 190 for example in FIG. 1;
whether the enclosure is intended for storage, shipping, covering spa system in final user intended position, etc. discretely or a combination thereof;
the mechanical geometry of the spa system; the geographical location and/or region for the spa system and thereby its anticipated temperatures during which the enclosure is expected to be employed; and
the location and performance of insulation within the outer shell of the spa system.

Within each of first to fourth Enclosures 1700A to 1700D the controller connected to the heating elements may also vary the heating pattern, heating voltage(s) and/or current(s) applied to the heating elements in dependence upon one or more factors. Such factors and other factors, may include, but not be limited to:
the shape of the spa system;
the positioning of one or more pumps of the spa system such as Massage Pump 125 and Circulation Pump 165 in FIG. 1 for example;
a layout of the piping and/or other fluid based elements of the spa system such as Piping 110, 3-way Valves 115, Blower 120, Suction Inlet 130, Hoses 140, Back Jets 145, Manifolds 150, Massage Jets 155, and Air Jets 185 for example in FIG. 1;
a status of one or more other heating elements associated with the spa system, such as Water Heater 190 for example in FIG. 1;
whether the enclosure is intended for storage, shipping, covering spa system in final user intended position, etc. discretely or a combination thereof;
the mechanical geometry of the spa system; the geographical location and/or region for the spa system and thereby its anticipated temperatures during which the enclosure is expected to be employed; and
the location and performance of insulation within the outer shell of the spa system.

Accordingly, even a relatively simple enclosure design such as first Enclosure 1700A in FIG. 17 may be programmed for a specific spa system or range of spa systems or contain programs for a number of spa systems wherein an initial set up process of the controller includes defining the spa system with which the enclosure will be employed. In this manner the controller can also adjust the heating applied to all or some regions of the enclosure.

Within other embodiments of the invention the enclosure may include one or more temperature sensors which are coupled to the controller to provide data for dynamic heater management by the controller such that it offers improved power consumption in “warmer” periods than always running at a power for the “colder” periods.

Within other embodiments of the invention the enclosure may include one or more temperature sensors which are upon a cable coupled to the controller to provide data for temperature of the water within the spa system. Accordingly, these one or more temperature sensors are deployed within the water of the spa system and provide temperature data to the controller. These one or more temperature sensors may be permanently coupled to the enclosure or demountably coupled via an electrical connector. Within other embodiments of the invention a wireless temperature sensor may be coupled to a wireless interface of the enclosure.

Within other embodiments of the invention the enclosure may include one or more sensors such as a vibration sensor, accelerometer, inclinometer, etc. For example, a vibration sensor may provide data to the controller with respect to the operation of the normal active elements of the spa system, e.g., by detecting vibration induced by the pump(s) of the spa system. According to an embodiment of the invention the controller may power the enclosure upon detecting a lack of vibration which may imply a failure in the pump and/or power to the active elements of the spa system for example. Alternatively, the vibration sensor may be attached to the spa system or an active element of the spa system.

Within an embodiment of the invention the Enclosure such as described and depicted may comprise an inner shell, an outer shell, a series of heater elements and one or more layers of insulation.

The construction, as visualized in cross-section for an embodiment of the invention, may be the inner shell, the series of heater elements, the one or more layers of insulation and the outer shell.

The construction, as visualized in cross-section for another embodiment of the invention, may be the inner shell, a subset of the layers of insulation, the series of heater elements, the remaining layers of insulation and the outer shell.

Within another embodiment of the invention the construction, as visualized in cross-section, may be the inner shell, the series of heater elements, and the one or more layers of insulation as the outer shell.

Within embodiments of the invention the heater elements may be within the inner shell.

Within embodiments of the invention the Enclosure may be formed as a sheet that is draped over the spa system. This may be retained in position by means as known in the art including for example, but not limited to, one or more straps, snap fit fasteners (e.g., slide release buckles), hook-and-eye fasteners (e.g., Velcro™), buttons, ropes etc. In this manner the Enclosure may be fitted to a range of spa systems of different dimensions/geometries.

Within embodiments of the invention the Enclosure may be formed as a bag that is slid over the spa system. This may be retained in position and/or closed by means as known in the art including for example, but not limited to, one or more straps, snap fit fasteners (e.g., slide release buckles), hook-and-eye fasteners (e.g., Velcro™), buttons, ropes etc. In this manner the Enclosure may be fitted to a range of spa systems of different dimensions/geometries.

Within embodiments of the invention the Enclosure may be formed as a formed housing with defined wall(s), top and/or bottom that is placed over the spa system. This may be retained in position by means as known in the art including for example, but not limited to, one or more straps, snap fit fasteners (e.g., slide release buckles), hook-and-eye fasteners (e.g., Velcro™), buttons, ropes etc. In this manner the Enclosure may be fitted to a more limited range of spa systems and/or a single spa system.

As described and depicted below in respect of FIGS. 18 and 19 the controller may be integral to the enclosure or be disposed separately to the enclosure. However, within other embodiments of the invention it may be coupled to a controller of the spa system (e.g., Control System 105 in FIG. 1) or to another controller forming part of another anti-freeze protection system for the spa system such as described and depicted below in respect of FIGS. 5 to 7 respectively.

Accordingly, in order to establish a system with improved tolerance to a wider variety of fault mechanisms the inventor has established a different design methodology in respect of spa systems. Referring to FIG. 18, there is depicted a backup system for a spa system according to an embodiment of the invention. Accordingly, as depicted a first GFCI 1810 couples a first electrical cable 1820 to a first Electrical Connector 1830A whilst a second GFCI 1815 couples a second electrical cable 1825 to a second Electrical Connector 1830B. The first Electrical Connector 1830A is coupled to a Controller 1860 which is coupled to a Pump 1870 and a Heater 1880 and accordingly functions in a manner similar to that depicted in respect of FIG. 4 and as known in the prior art for the active elements of the spa system. The second Electrical Connector 1830B is coupled to Enclosure 1890 which by virtue of the second electrical cable 1825 and second GFCI is coupled to a different electrical supply than that powering the Controller 1860, Pump 1870 and Heater 1880. Optionally, the first and second electrical circuits may be routed through a common electrical connector rather than a pair of electrical connectors although the electrical paths/circuits for the Enclosure 1890 and the Controller 1860, Pump 1870 and Heater 1880 are separate. However, it would be evident that the Enclosure 1890 and Controller 1860, Pump 1870 and Heater 1880 could be powered from a single common electrical power source although this limits the backup protection in the event of a power outage.

The Enclosure 1890 may be according to an embodiment of the invention such as described and depicted with respect to first to fourth Enclosures 1700A to 1700D respectively in FIG. 2. In the event of a detection of a failure of the first electrical circuit within some embodiments of the invention and/or detection of a temperature within the spa system below a predetermined threshold temperate (set point temperature) then the second electrical circuit is engaged and/or the controller triggers the powering of the heater elements of the Enclosure 1890. In the event of a detection of a temperature within the spa system being below a predetermined threshold temperate (set point temperature) then the second electrical circuit is engaged and/or the controller triggers the powering of the heater elements of the Enclosure 1890.

A low complexity approach is to employ a secondary circuit and/or Enclosure 1890 which includes a thermostat (not depicted for clarity) set for, say 40° F. (approximately 5° C.) then the Enclosure 1890 will turn on automatically when the detected temperature drops to below 40° F. Accordingly, the Enclosure 1890 will operate irrespective of whether the first electrical circuit is live or dead and if live whether the Pump 1870 and Heater 1880 are functioning. Optionally, rather than an electrical thermostat providing a control signal to the Enclosure 1890 may be coupled to the second electrical circuit via one or more mechanical temperature switches exploiting, for example, bimetallic elements to make the electrical connections or cause a conductive fluid to make the contact (e.g., mercury). Alternatively, a mechanical switch based upon mechanical expansion/contraction with temperature may be employed, such as a so-called “snap disc” or “snap-action” thermostat may be employed. Optionally, the first electrical circuit may be disconnected through mechanical temperature dependent switches such that the Heater 1880 and/or Pump 1870 are disconnected discretely or in combination with the Controller 1860.

Now referring to FIG. 19, there is depicted a Spa System 1950 according to an embodiment of the invention. As depicted the physical configuration is essentially identical to that depicted in FIG. 18 with the exception of the addition of a Battery Backup 1910 disposed within the second electrical circuit prior to the Enclosure 1890. Battery Backup 1910 may, for example, be a primary battery designed to be replaced after use or a secondary battery designed to be recharged and to maintain charge through a so-called “trickle” charging process. In the event of a detection of a failure of the first electrical circuit within some embodiments of the invention and/or detection of a temperature within the spa system below a predetermined threshold temperate (set point temperature). Accordingly, considering a thermostat initiated powering of the Enclosure 1890 then upon detection of a temperature below the set point temperature of the thermostat the thermostat couples the Enclosure 1890 to the first electrical circuit which now includes the Battery Backup 1910. Accordingly, if the second electrical circuit is active then the Enclosure 1890 operates from the electrical mains but in the event of a failure to the second electrical circuit (e.g., a power failure (commonly referred to as a power cut) the Battery Backup 1910 provides electrical power to the Enclosure 1890.

It would be evident that systems exploiting Battery Backup 1910 may provide protection even in the event of a triggering of a main circuit breaker associated with the spa system, multiple circuit breakers associated with the spa system, and the mains power feed to the spa system and/or its associated property etc. failing (e.g., power cut).

As the Enclosure 1890 is intended to maintain a temperature sufficiently above freezing to protect the fluidic system, comprising Tub 1840 and ancillary elements such as Piping 110, Jets Hoses 140, Back Jets 145, and Manifolds 150 as depicted in FIG. 1, rather than heat the water for use of the Tub 1840 the power requirements are significantly reduced. The materials of the Enclosure 1890 may, within embodiments of the invention, include those employed in what are commonly referred to as “solar covers” or “solar blankets” to exploit available sunlight in order to adjust one or more of the onset of powering the Enclosure 1890, the length of time the Enclosure 1890 can operate, or the power consumption of the Enclosure 1890.

Within other embodiments of the invention according to the design of the Spa System 450 the Enclosure 1890 discretely or in combination with Battery Backup 410 may be a feature of the Spa System 450 when purchased by the user or alternatively added subsequently as an upgrade or retrofit option for the user.

The Enclosure 1890 may, within embodiments of the invention, be used during transportation and/or storage of the spa system through a mains electrical interface, generator, battery etc. In these instances, the Enclosure 1890 may prevent any water within the spa system from freezing during transportation and/or storage of the spa system or be employed as part of a pre-warming process of the spa system to limit any freezing upon filling the spa system. In this manner, filling and/or installation of the spa system may through use of an Enclosure 1890 according to an embodiment of the invention be undertaken at lower temperatures than possible previously.

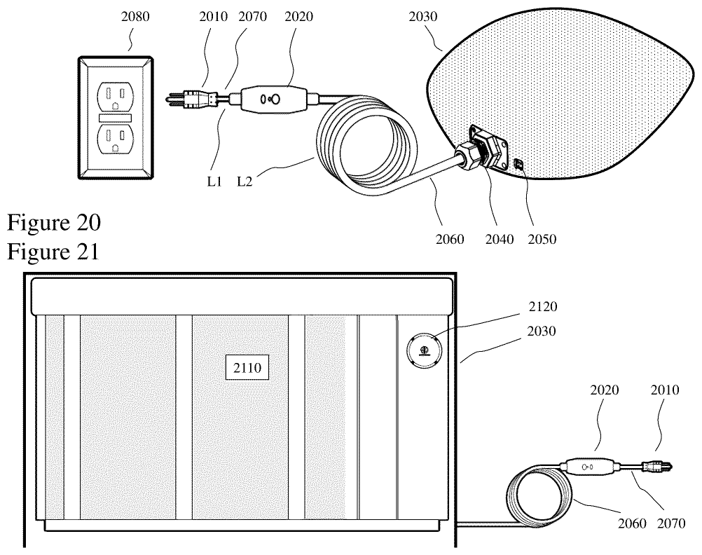

Now referring to FIG. 20, there is depicted an Enclosure 2030 for use in conjunction with an enclosure according to an embodiment of the invention for use with a spa thermal management system. As depicted the Enclosure 2030 comprises a Mains Electrical Port 2040 which is connected to a first Cable 2060 and therein to an Inline GFCI 2020, a second Cable 2070 and an Electrical Plug 2010. The Main Electrical Port 2040 “hard wires” the Enclosure 2030 to the first Cable 2060 although within other embodiments of the invention the Enclosure 2030 may be connected to the first Cable 2060 via a demountable connector if local electrical regulations allow.

The Electrical Plug 2010 for connection to a GFCI Socket 2080, such as first GFCI 1810 or second GFCI 1815 in FIGS. 18 and 19 for example, such as on the outer wall of a building or property. The GFCI Socket 2080, may for example, be separate from a GFCI and electrical connection for the spa system (not depicted for clarity) such that triggering of the GFCI for the spa system due to a fault does not automatically disrupt power to the Enclosure 2030. Accordingly, the In-Line GFCI 2020 allows the Enclosure 2030 to be connected also to a non-GFCI socket rather than a GFCI Socket 2080. Optionally, the mating of the Electrical Plug 2010 and GFCI Socket 2080 which is depicted as male connector (on Electrical Plug 2010) to female socket (on GFCI Socket 2080) may be reversed to female socket (on Electrical Plug 2010) to male connector (on GFCI Socket 2080) or other configurations via an intermediate adapter. Also depicted on the Enclosure 2030 is a Control Port 2050.

The In-Line GFCI 2020 allows for the Enclosure 2030 to comply, in some deployment scenarios, with regulatory requirements. The length of the first Cable 2060 deployed from the location of the In-Line GFCI 2020 to Enclosure 2030 may be sufficient to prevent a user reaching both simultaneously or concurrently such that in the event of the In-Line GFCI 2020 tripping the user cannot be in contact with the Enclosure 2030 and reset the In-Line GFCI 2020. In other instances, the length of the first Cable 2060 deployed from the location of the In-Line GFCI 2020 to the nearest point on the spa system may be defined to prevent a user reaching both simultaneously or concurrently.

Accordingly, the In-Line GFCI provides ground fault protection and/or circuit interruption of the electrical power to the Enclosure 2030. As depicted the length of the second Cable 2070 between the Electrical Plug 2010 to the In-Line GFCI 2020 is L1 and the length of the first Cable 2060 between the In-Line GFCI 2020 and the Enclosure 2030 is L2. The lengths L1 and L2 or a total length L1+L2 may be defined by one or more of a local electrical regulatory requirement, a manufacturer of the heater system, and an installer of the heater system. Optionally, L2 may be adjusted by a qualified electrical technician removing the first Cable 2060 from the Enclosure 2030 at Main Electrical Port 2040 and extending/shortening the first Cable 2060 and re-connected to the Main Electrical Port 2040.

The Main Electrical Port 2040 may be a demountable connector within other embodiments of the invention.

The Enclosure 390 may be according to an embodiment of the invention such as described and depicted with respect to first to fourth Enclosures 18A to 18D respectively in FIG. 2.

Referring to FIG. 21 there is depicted a deployment configuration for an Enclosure 2030 according to an embodiment of the invention with a Spa 2110 to provide a spa thermal management system according to an embodiment of the invention. As depicted the Enclosure 2030 again comprises the first Cable 2060, Inline GFCI 2020, the second Cable 2070 and Electrical Plug 2010. As depicted in FIG. 21 the Enclosure 2030 is placed over, although it may within other embodiments be slid over, the Spa 2110. Also mounted to the Spa 2110 is Controller 2120 which may, for example, provide a visual indication of the operation state of the Enclosure 2030 as well as a wireless interface for pushing status data relating to the Enclosure 2030 to a remote electronic device and/or receiving control data etc. from another remote electronic device.

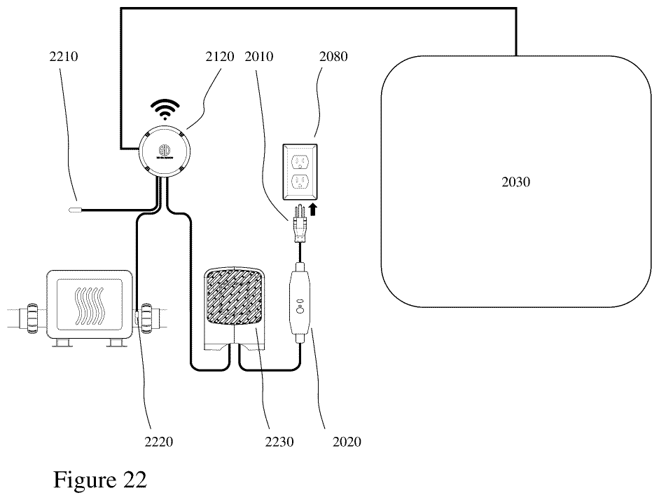

Now referring to FIG. 22 depicts a configuration of Controller 2120, Heater 2230, Enclosure 2030 and temperature sensors according to an embodiment of the invention for use with a spa thermal management system. The Heater 2230 is connected in common with FIGS. 20 and 21 to an In-Line GFCI 2020 and Mains Connector 2010 for connecting to GFCI Socket 2080 (or other electrical power interface). The Heater 2230 and Enclosure 2030 are also connected to the Controller 2120. Controller 2120 being coupled to first and second Temperature Sensors 2210 and 2220, respectively. First Temperature Sensor 2210 provides for monitoring the temperature of the cavity of the spa system the Heater 2230 is deployed within whilst second Temperature Sensor 2220 provides for monitoring of the temperature of the piping of the spa system (and thereby the water temperature).

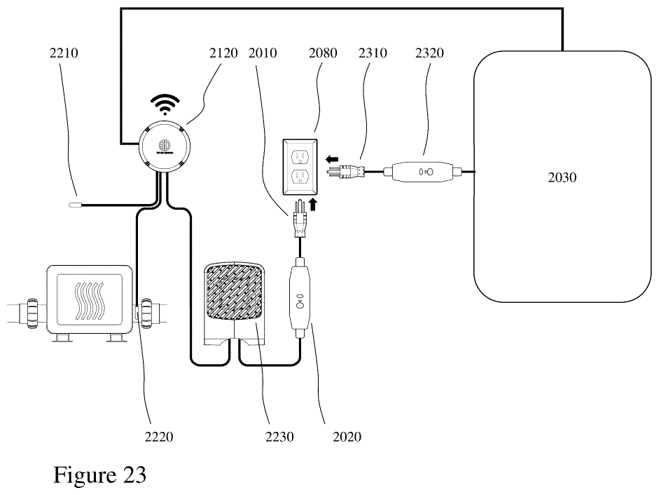

Alternatively, as depicted in FIG. 23 the Enclosure 2030 may be coupled to the GFCI Socket 2080 (or other electrical power interface) via a second In-Line GFCI 2320 and second Mains Connector 2310 for the power but receive command signal(s) from the Controller 2120. Heater 2230 may be, for example, according to an embodiment of the invention such as described by the inventor within World Intellectual Property Office Patent Application WO2019033195 filed Aug. 16, 2018 (with priority to U.S. Provisional Patent Application 62/546,088 filed Aug. 16, 2017) and U.S. Provisional Patent Application 63/263,967 filed Apr. 29, 2022.

In this manner the spa system may be provided with auxiliary heating to prevent the spa system from freezing by the Enclosure 2030 and/or Heater 2230. For example, the Enclosure 2030 may be triggered to heat the spa system when a temperature established by one or both of the first Temperature Sensor 2210 and second Temperature Sensor 2220 drops below a predetermined threshold or thresholds for each of the first Temperature Sensor 2210 and second Temperature Sensor 2220. The Heater 2230 may then be triggered when the temperature established by one or both of the first Temperature Sensor 2210 and second Temperature Sensor 2220 drops below another predetermined threshold or predetermined thresholds for each of the first Temperature Sensor 2210 and second Temperature Sensor 2220.

Within embodiments of the invention the Enclosure may be coupled to the Controller via one or more electrical cables that provide power to the heater elements within the Enclosure. Within embodiments of the invention the heater elements may be coupled to the Controller via one or more electrical cables that provide power to the heater within the Enclosure where predetermined subsets are coupled to each cable and may be powered differently to other subsets. Within embodiments of the invention the Enclosure may integrate the Controller within it. Within embodiments of the invention the heater elements may be coupled to the Controller wherein predetermined subsets are powered differently to other subsets.

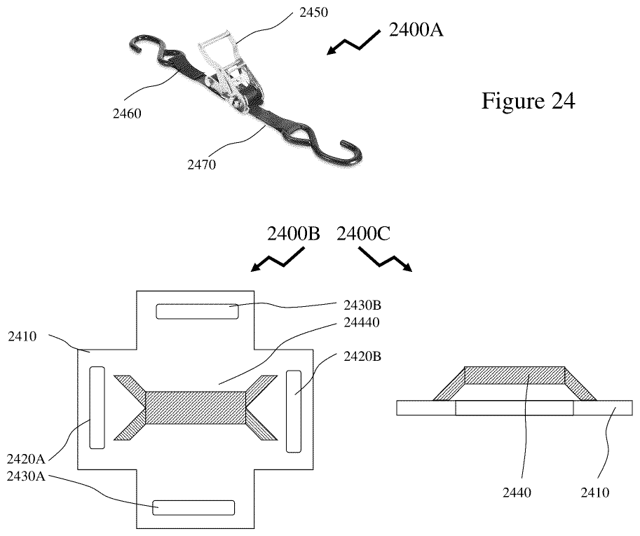

Referring to FIG. 24 there is depicted a handle for demountable attachment to a ratchet tie-down strap or straps according to an embodiment of the invention. An example of a ratchet tie-down strap being depicted in first Image 2400A wherein a first strap 2460 is typically fixedly attached to the ratcheting Mechanism 2450 and a second strap 2470 is wound onto a drum of the ratcheting mechanism such that the ratchet tie-down strap can be tightened, typically around an object or group of objects, to hold them together for moving, storage etc. Two or more ratchet tie-down straps may be employed along long objects or at right angles in other instances. The ratchet tie-down strap being depicted in first Image 2400A having hooks at the ends of the first Strap 2460 and second Strap 2470 although other means of attaching the first Strap 2460 to the second Strap 2470 to form a loop that is tightened or to the object(s) etc. may be employed.

However, the problem is now to carry the object or objects which the ratchet tie-down straps surround. Accordingly, the inventors have established a carry means as depicted in second and third Images 2400B and 2400C respectively in plan and side elevation views. As depicted the carry means comprises a Body 2410 having a Handle 2440 attached to it. The Body 2410 being in a “cross” shape. Disposed at the ends of the Body 2410 along an axis of the Handle 2440 are first and second Openings 2420A and 2420B respectively. Disposed at other ends of the Body 2410 along an axis perpendicular to the Handle 2440 are third and fourth Openings 2430A and 2430B respectively. Accordingly, the flat end of a second Strap 2470 of a ratchet tie-down strap is fed through, for example, first Opening 2420A, under the Body 2410 and back through the second Opening 2420B before being attached to the ratcheting Mechanism 2450 such that when the ratcheting Mechanism 2450 is engaged and the second Strap 2470 wound upon the ratcheting Mechanism 2450 the object(s) are restrained/retained within a loop formed by the first Strap 2460 and second Strap 2470. Accordingly, a user can then use the Handle 2440 to carry the object(s).

Accordingly, the flat end of a second Strap 2470 of the ratchet tie-down strap is fed through, for example, first Opening 2420A, across the Body 2410 and back through the second Opening 2420B before being attached to the ratcheting Mechanism 2450. In this manner the second Strap 2470 is between the Handle 2440 and Body 2410.

Due to “cross” shape of the design depicted then the flat end of another second Strap 2470 of another ratchet tie-down strap may be fed through third Opening 2430A, under the Body 2410 and back through the fourth Opening 2430B being attached to another ratcheting Mechanism 2450 such that when the another ratcheting Mechanism 2450 is engaged and the another second Strap 2470 wound upon the ratcheting Mechanism 2450 the object(s) are restrained/retained within a loop formed by the another first Strap 2460 and another second Strap 2470.

Alternatively, the flat end of another second Strap 2470 of another ratchet tie-down strap may be fed through third Opening 2430A, across the Body 2410 and back through the fourth Opening 2430B being attached to another ratcheting Mechanism 2450. In this manner the another second Strap 2470 is between the Handle 2440 and Body 2410.

Alternatively, a single ratchet tie-down strap may be employed through the third Opening 2430A and fourth Opening 2430B. Optionally, a carry means may not be cross shaped and employ only first and second Openings 2420A and 2420B respectively. Optionally, other geometries of the Body 2410 may be employed to support one, two or more ratchet tie-down straps.

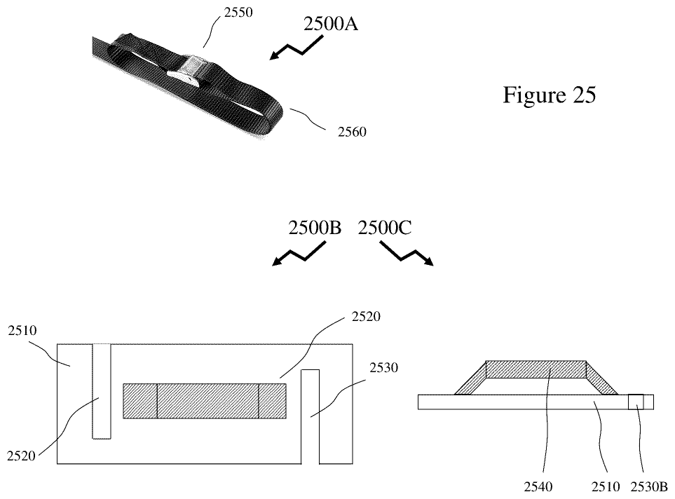

Now referring to FIG. 25 there is depicted a handle for demountable attachment to an endless cam buckle style tie down according to an embodiment of the invention. An example of a ratchet tie-down strap being depicted in first Image 2500A with the Loop 2560 and Cam Buckle 2550. Accordingly, the inventors have established a carry means as depicted in second and third Images 2500B and 2500C respectively in plan and side elevation views. As depicted the carry means comprises a Body 2510 having a Handle 2540 attached to it. Disposed at one end is a first Slot 2520 and at the other end a second Slot 2530. Accordingly, the Loop 2560 of the endless cam buckle style tie down is slid into the first Slot 2520 and the second Slot 2530 such that the Loop 2560 runs beneath the Body 2510.

Within another embodiment of the invention the Handle 2540 may be formed such that Loop 2560 of the endless cam buckle style tie down is slid into the first Slot 2520 and the second Slot 2530 such that the Loop 2560 runs above the Body 2510.

Within another embodiment of the invention the first Slot 2520 and second Slot 2530 may be disposed on the same side of the Body 2510 rather than opposite sides. Optionally, additional slots may be formed on other sides of the Body 2510 to support use of the carrying means with 2 or more endless cam buckle style tie downs.

The Body 2410 or Body 2510 may be formed from a metal, alloy, ceramic, plastic, or fiber-reinforced plastic for example.

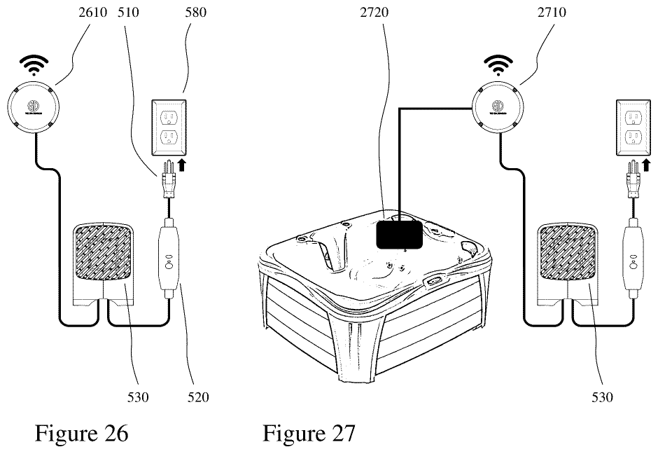

Now referring to FIG. 26 there is depicted a configuration of controller and heater according to an embodiment of the invention. The Heater 530 is connected in common with FIGS. 5 and 6 to an In-Line GFCI 520 and 510 for connecting to GFCI Socket 580 (or other electrical power interface). Heater 530 is also connected to Controller 2610. The Controller 2610 incorporates a wireless interface such that the Controller 2610 can be controlled remotely via a wireless network. Accordingly, a remote user can enable the Heater 530 from a remote electronic device. Optionally, Controller 2610 may be integrated within the Heater 530. Optionally, the Heater 530 may be connected to a battery or alternate means of providing electrical power other than to an electrical mains via GFCI Socket 580.

Referring to FIG. 27 there is depicted a configuration of controller and heater according to an embodiment of the invention. As depicted the configuration in FIG. 27 is similar to that depicted in FIG. 26 except that the Controller 2710 is now also connected to Electronics 2720 of a spa as well as the Heater 530. The Electronics 2720 may be, for example the Control System 105 as depicted in FIG. 1 or another module interfacing to the Control System 105. Accordingly, the Controller 2710 may monitor the Electronics 2720 and/or be provided with status communications from the Electronics 2720 as to the status and/or operational parameters/performance of elements of the spa such as one or more of Blower 120, Massage Pump 125, Air Controls 160, Circulation Pump 165, Control Panel 170 and Water Heater 190 for example.

Accordingly, a failure of an element of the spa may be identified by the Controller 2710 and communicated to a remote user, e.g., owner of the spa or a maintenance individual associated with the spa by the owner for example. Based upon the information provided to the user by the Controller 2710 the user may elect to enable the Heater 530 from a remote electronic device. Optionally, depending upon the functionality provided by the Controller 2710 the user may also power down the spa or portion of the spa, e.g., Electronics 2720 when it is also the Control System 105 or the Control System 105 and/or Electronics 2720 when separate elements.

Optionally, Controller 2710 may be integrated within the Heater 530. Optionally, the Heater 530 may be connected to a battery or alternate means of providing electrical power other than to an electrical mains via a GFCI socket for example.

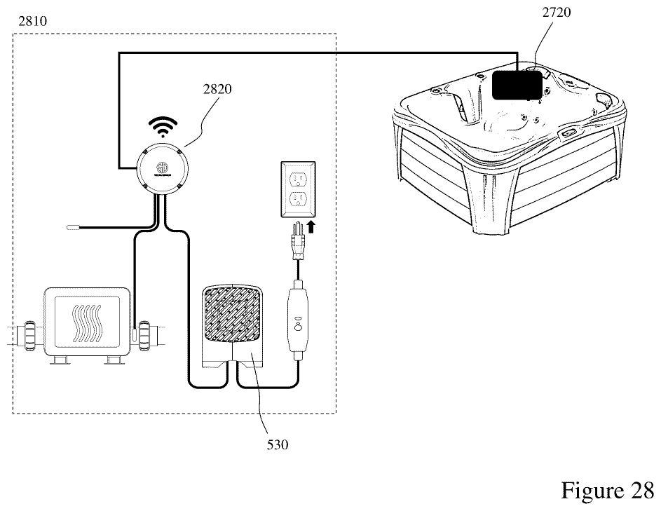

Now referring to FIG. 28 there is depicted a configuration of controller and heater according to an embodiment of the invention. The Block 2810 is equivalent to the configuration as depicted in FIG. 7 but now the Controller 2820 is also interfaced to the Electronics 2720 of the spa. Accordingly, the Controller 2820 may operate as described above with respect to embodiments of the invention to automatically turn on the heater in dependence upon readings from one or more temperature sensors. However, the Controller 2820 may also receive data from the Electronics 2720 as described and depicted above in respect of FIG. 27 such that this information is parsed and provided to a user wherein the heater can then be remotely enabled by the user prior to its automatic triggering in dependence upon the threshold(s) established within the Controller 2820 in conjunction with the reading(s) from the temperature sensor(s).

Optionally, Controller 2610 may be integrated within the Heater 530. Optionally, the Heater 530 may be connected to a battery or alternate means of providing electrical power other than to an electrical mains via a GFCI socket for example.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A heater system comprising:
a heater for coupling to an electrical mains comprising a power converter, a protection circuit, a fan and a heater element; and
a controller electrically coupled to the heater for receiving a power signal from the power converter and providing a control signal to the heater to enable or disable the heater via the protection circuit.

2. The heater system according to claim 1, wherein
the heater is connected to the electrical mains via an electrical cable incorporating an in-line ground fault circuit interrupter (GFCI).

3. The heater system according to claim 1, wherein
the heater is connected to the electrical mains via an electrical cable incorporating an in-line ground fault circuit interrupter (GFCI);
the controller comprises a control circuit for determining whether to enable or disable the heater in dependence upon a first temperature measurement and a second temperature measurement;
the first temperature measurement is generated by a first temperature sensor monitoring a temperature of a cavity within which the heater is to be disposed; and
the second temperature measurement is generated by a second temperature sensor monitoring a temperature of the controller.

4. The heater system according to claim 1, wherein
the heater is connected to the electrical mains via an electrical cable incorporating an in-line ground fault circuit interrupter (GFCI);
the controller comprises a control circuit for determining whether to enable or disable the heater in dependence upon a first temperature measurement and a second temperature measurement;
the first temperature measurement is generated by a first temperature sensor monitoring a temperature of a cavity of a spa system within which the heater is to be disposed; and
the second temperature measurement is generated by a second temperature sensor monitoring a temperature of a pipe forming part of the spa system.

5. The heater system according to claim 1, wherein
the protection circuit comprises a temperature comparator for determining whether a first temperature measurement generated by a first temperature sensor monitoring a temperature of the heater exceeds a first predetermined threshold temperature or not or is below a second predetermined threshold temperature or not;
upon determining the first temperature measurement exceeds the first predetermined threshold temperature the temperature comparator generates a control signal to disable an electrical connection between the electrical mains and the heater element; and
upon determining the first temperature measurement is below the second predetermined threshold temperature the temperature comparator generates the control signal to enable the electrical connection between the electrical mains and the heater element.

6. The heater system according to claim 1, wherein
the heater element is coupled to the electrical mains via a first relay; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

7. The heater system according to claim 1, wherein
the heater element is coupled to the electrical mains via a first relay, a first thermal cutoff and a second thermal cutoff;
the first relay is enabled or disabled in dependence upon the control signal from the controller;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature.

8. The heater system according to claim 1, wherein
the heater element is coupled to the electrical mains via a first relay, a first thermal cutoff and a second thermal cutoff;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

9. The heater system according to claim 1, wherein
the heater is connected to the electrical mains via an electrical cable incorporating an in-line ground fault circuit interrupter (GFCI);
the heater element is coupled to the electrical mains via a first relay, a first thermal cutoff and a second thermal cutoff;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

10. A heater system comprising:
an electrical cable coupled to the heater at a first end and having an electrical connector disposed at a second distal end for connection to an electrical mains;
a protection circuit coupled to the first end of the electrical cable and to a heater element;
a fan; and
the heater element; wherein
the electrical cable incorporates an in-line ground fault circuit interrupter (GFCI).

11. The heater system according to claim 10, wherein
the heater further comprises a controller electrically coupled to the heater for receiving a power signal from the power converter and providing a control signal to the heater to enable or disable the heater via the protection circuit; and
the controller is coupled to the heater via another electrical cable and a demountable connector having a first portion on the another electrical cable and a second portion on the heater.

12. The heater system according to claim 10, wherein
the heater further comprises a controller electrically coupled to the heater for receiving a power signal from the power converter and providing a control signal to the heater to enable or disable the heater via the protection circuit;
the controller comprises a control circuit for determining whether to enable or disable the heater in dependence upon a first temperature measurement and a second temperature measurement;
the first temperature measurement is generated by a first temperature sensor monitoring a temperature of a cavity within which the heater is to be disposed; and
the second temperature measurement is generated by a second temperature sensor monitoring a temperature of the controller.

13. The heater system according to claim 10, wherein
the heater further comprises a controller electrically coupled to the heater for receiving a power signal from the power converter and providing a control signal to the heater to enable or disable the heater via the protection circuit;
the controller comprises a control circuit for determining whether to enable or disable the heater in dependence upon a first temperature measurement and a second temperature measurement;
the first temperature measurement is generated by a first temperature sensor monitoring a temperature of a cavity of a spa system within which the heater is to be disposed; and
the second temperature measurement is generated by a second temperature sensor monitoring a temperature of a pipe forming part of the spa system.

14. The heater system according to claim 10, wherein
the protection circuit comprises a temperature comparator for determining whether a first temperature measurement generated by a first temperature sensor monitoring a temperature of the heater exceeds a first predetermined threshold temperature or not or is below a second predetermined threshold temperature or not;
upon determining the first temperature measurement exceeds the first predetermined threshold temperature the temperature comparator generates a control signal to disable an electrical connection between the electrical mains and the heater element; and
upon determining the first temperature measurement is below the second predetermined threshold temperature the temperature comparator generates the control signal to enable the electrical connection between the electrical mains and the heater element.

15. The heater system according to claim 10, wherein
the heater element is coupled to the electrical mains via a first relay; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

16. The heater system according to claim 1, wherein
the protection circuit comprises a first relay, a first thermal cutoff and a second thermal cutoff;
the first relay is enabled or disabled in dependence upon the control signal from the controller;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature.

17. The heater system according to claim 10, wherein
the protection circuit comprises a first relay, a first thermal cutoff and a second thermal cutoff;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

18. The heater system according to claim 10, wherein
the protection circuit comprises a first relay, a first thermal cutoff and a second thermal cutoff;
the first thermal cutoff is a normally closed temperature dependent switch that open if a temperature within the heater exceeds a first temperature limit;
the second thermal cutoff is a normally closed temperature dependent switch that open if the temperature within the heater exceeds a second temperature limit and closes again if the temperature within the heater drops below a third temperature offset below the second temperature by an offset temperature; and
the control signal enables or disables a second relay which controls application of a voltage to the first relay such that the electrical mains is connected to the heater element when the control signal enables the second relay such that the voltage is applied to the first relay to close the first relay and the electrical mains is disconnected when the control signal disables the second relay such that no voltage is applied to the first relay such that the first relay is open.

19. A heater system comprising:
an enclosure comprising:
a flexible sheet; and
a plurality of heater elements disposed in a predetermined pattern; and
the controller which electrically coupled to the plurality of heater elements to provide electrical signals to the plurality of heaters; wherein
the enclosure when disposed around a predetermined portion of a spa system heats another predetermined portion of the spa system via the electrical power heating the plurality of heaters.

20. The heater system according to claim 19, wherein
the controller comprises:
a port for receiving electrical power from an electrical power supply;
a control circuit for determining whether a temperature of the another predetermined portion of the spa system has dropped below a predetermined threshold and applying the electrical signals to the plurality of heaters upon a positive determination; and
one or more electrical interfaces coupled to the plurality of heaters.

21. The heater system according to claim 19, wherein
the controller comprises:
a port for receiving power signal from an electrical power supply;
a control circuit for determining whether an active element of the spa system has ceased operating in dependence upon data received from a vibration sensor and applying the electrical signals to the plurality of heaters upon a positive determination; and
one or more electrical interfaces coupled to the plurality of heaters.

22. The heater system according to claim 3, wherein
the vibration sensor is one of:
attached to the spa system;
attached to the active element of the spa system; and
forms part of the enclosure.

23. The heater system according to claim 19, wherein
the predetermined pattern is defined in dependence upon at least one of a specific spa system and a set of spa systems.

24. The heater system according to claim 19, wherein
the predetermined pattern is defined in dependence upon at least one of a location of a portion of
the spa system containing water accommodating a human user, a location of an active element of
the spa system, a layout of the spa system and a layout of insulation forming part of the spa system.

25. The heater system according to claim 19, wherein
the plurality of heaters comprise a plurality of sets of heaters;
each set of heaters associated with a predetermined portion of the enclosure; and
each predetermined portion of the enclosure covers a different predetermined portion of the spa system.

26. The heater system according to claim 19, wherein
each different predetermined portion of the spa system is selected from the group comprising a portion of a wall of the spa system, a portion of a side of the spa system, a portion of a top of the spa system, a portion of the bottom of the spa system.

27. The heater system according to claim 19, wherein
the controller is connected to an electrical mains via an electrical cable incorporating an in-line ground fault circuit interrupter (GFCI).
